(19) United States
(12) Patent Application Publication
(10) Pub. No.: US 2021/0406814 A1
(43) Pub. Date: Dec. 30, 2021

(54) Systems and Methods for Using a Machine-Readable Code in Relation to a Cannabis Product

(71) Applicant: HEXO Operations Inc., Ottawa (CA)

(72) Inventors: Max ALSAYAR, Saint-Joseph Gatineau (CA); Denis KESERIS, Montreal (CA); Stephan GEORGIEV, Montreal (CA); Jeff LEUSCHNER, Montreal (CA)

(21) Appl. No.: 17/284,067

(22) PCT Filed: Oct. 11, 2019
(86) PCT No.: PCT/CA2019/051452

§ 371 Date: Apr. 9, 2021

Related U.S. Application Data
(60) Provisional application No. 62/745,042, filed on Oct. 12, 2018.

(51) Int. Cl. G06Q 10/08; G06Q 20/38; G06K 7/14; G06F 16/955; G06F 16/9535

(52) U.S. Cl. CPC G06Q 10/087; G06Q 20/389; G06F 16/9535; G06F 16/955; G06K 7/1443

(57) ABSTRACT

Producers of cannabis products want to produce cannabis products that are not only safe, but that also induce an effect that is desirable to the consumer. Producers may also want to provide information about a cannabis product to consumers and/or retailers. Producers may also want to receive information from and about consumers and/or retailers. It is desired to use computer technology to help achieve one or more of these objectives. Computer-network-based systems and methods are disclosed in which a machine-readable code (e.g. barcode) from a cannabis product is used to help address different technical problems that may arise.

### CROSS-REFERENCE TO RELATED APPLICATION

This application claims priority from U.S. Provisional Patent Application 62/745,042 filed on 12 Oct. 2018, and which is hereby incorporated by reference.

### FIELD

The following relates to machine-readable codes for cannabis products, and a computer-network-based system that uses a machine-readable code from a cannabis product.

### BACKGROUND

Cannabis producers cultivate and harvest cannabis plants, and the harvested plants are processed to produce cannabis products. A cannabis product may primarily consist of the processed cannabis plants themselves, e.g. dried buds (flowers), dried trim, grinded (milled) product, cannabis oil or concentrate (e.g. resin, distillate or wax). However, as used herein, a cannabis product is any product that is or incorporates cannabis, such as the active components of cannabis, e.g. the cannabinoids (e.g. D9-Tetrahydrocannabinol (THC) and Cannabidiol (CBD)). Therefore, a cannabis product may include other ingredients that do not originate from a cannabis plant, e.g. essential oils, terpenes, natural flavours, artificial flavours, and/or other ingredients to impact the flavour, fragrance, look, and/or texture of the product. For example, a cannabis product may be an edible or a drink that incorporates cannabis. As another example, a cannabis product may be a massage oil including cannabis and fragrances. A cannabis product also encompasses a cannabis accessory that contains cannabis when sold.

A unit of cannabis product is a discrete entity of cannabis product to be sold. For example, the cannabis product may be dried buds, and a unit of the cannabis product may be an individual container of dried buds offered for sale.

A cannabis product is consumed to induce an effect. Depending upon the cannabis product, it may be consumed by ingestion, vaping, smoking, topical application, etc. Different cannabis products may induce different effects. Some effects result in a temporary change in perception, mood, consciousness, and/or behavior. A ‘high’ may be induced. Other effects may also or instead be induced. One significant factor that influences the effect induced by a cannabis product is the cannabinoid profile of the product. Cannabis plants can exhibit variation in the quantity and/or type of cannabinoids they produce. The mixture of cannabinoids produced by a plant is known as the plant's cannabinoid profile. Different cannabinoids in different concentrations typically produce different effects. A cannabis plant may also have a terpene profile based on the unique blend and ratio of terpenes found in a specific strain of a cannabis plant.

Producers want to produce cannabis products that are not only safe and compliant with regulations, but that also induce an effect that is desirable to the consumer. Producers may also want to provide information related to a cannabis product to consumers and/or retailers. Producers may also want to receive information from and about consumers and/or retailers. It is desired to use computer technology to help achieve objectives such as these.

### SUMMARY

Computer-network-based systems and methods are disclosed in which a machine-readable code (e.g. barcode, QR code) from a cannabis product is used to help address different technical problems that may arise.

For example, a cannabis producer may wish to gauge use and/or desirability of a cannabis product, but there are challenges associated with a consumer feedback system. A manual approach of having the consumer complete a paper survey and return the completed survey back to the producer of the cannabis product is not practical or scalable, in part because many consumers will not make the effort required to return the completed survey. Oral feedback to a representative, e.g. in person or via the telephone, is also not practical or scalable, in part because of labour costs. If a consumer feedback system were to be implemented, then the solution would be to implement it using a computer-network. For example, the feedback may be collected via the consumer's personal electronic device (e.g. mobile device), and the feedback may be automatically transmitted over a network (e.g. the Internet) to a server, for retrieval by the producer.

However, there are specific technical problems associated with implementing a network-based consumer feedback system for cannabis products. One example technical problem is electronic linking of submitted feedback with a respective lot or batch of cannabis plants. A producer may sell a unit of cannabis product under a particular product brand, e.g. “Bedtime” dried buds targeted at consumers wishing to relax prior to bed. To maintain supply for the “Bedtime” brand cannabis product, batches of cannabis plants are cultivated and harvested over time. In an effort to make the “Bedtime” cannabis product more desirable, or because of other factors such as cost, some batches of cannabis plants may be cultivated using different cultivation techniques from other batches of cannabis plants. Also, batches are processed to produce lots, and the processing may differ for different lots of a same product. For example, the selection and/or proportion of non-cannabis based ingredients may be varied across different lots. A consumer's electronic device can be used to provide feedback in relation to a purchased container of “Bedtime” dried buds. However, without an electronic link back to the specific lot and/or specific batch of processed cannabis plants, the feedback may not be as useful to the producer.

Another example technical problem is authentication of feedback that is electronically submitted for a cannabis product. If a person can submit an electronic review of a cannabis product without even possessing that cannabis product, then a ‘fake review’ may be more easily submitted, which reduces the accuracy and usefulness of the feedback. It is desirable to electronically link the submitted feedback to a physical purchased unit of cannabis product to try to better ensure the validity of the feedback.

As another example, a consumer and/or retailer may wish to have a technical process to verify that a particular cannabis product is authentic. As another example, a cannabis producer may wish to have an easier way to transmit information about a cannabis product from their database directly to intended recipients. As another example, a cannabis producer may wish to extend electronic tracking to consumers who purchase cannabis products, e.g. so that the cannabis producer may learn information about its market (e.g. who is buying what and where). Technical solutions using a computer network and machine-readable codes are described in detail herein.

In one aspect, the machine-readable code may encode a number that identifies a batch of plants from which cannabis in the cannabis product originates. For example, the machine-readable code may encode the lot number of the cannabis product, which maps back to a batch of cannabis plants, e.g. via a mapping to a batch number. In another example, the machine-readable code may encode a batch number. In some embodiments, each cannabis product has a corresponding identifier encoded in the machine-readable code (e.g. a Global Trade Item Number (GTIN)), and the machine-readable code further encodes the lot number. Therefore, for example, two units of the same brand of cannabis product may have the same GTIN but different lot numbers. Although this causes the information encoded in the machine-readable code to possibly be different amongst different units of the same cannabis product (if the different units belong to different lots), a technical advantage is provided: the computer decoding the machine-readable code obtains an indication of the lot, which can be used by the computer to perform different actions discussed herein (e.g. link feedback to a lot, authenticate the product, obtain information relating to the lot, etc.).

In some aspects, systems/methods are provided that use the machine-readable code to electronically link feedback with an actual cannabis product and/or group of cannabis plants from which cannabis in the cannabis product originates. The feedback may comprise a consumer review of the cannabis product, but it may also or instead comprise information associated with the consumer or the consumer's electronic device (e.g. IP address of the electronic device, GPS coordinates of the electronic device, time and/or date information, a sensor reading from the electronic device, information previously entered by a user and stored in the memory of the electronic device, etc.). The feedback may be used for purposes such as: testing variations between lots in cultivation, harvesting, and/or processing techniques; and/or building consumer profiles; and/or better understanding use of the product; and/or tracking use of the product; etc.

In another aspect, systems/methods are provided that use a machine-readable code to verify information related to a cannabis product. For example, authenticity of the cannabis product may be verified. As another example, ability to sell or buy the cannabis product may be verified.

In another aspect, systems/methods are provided that use a machine-readable code to retrieve information specific to a cannabis product for use by a retailer. The information may be used for triaging the product, such as information used to categorize or sort the product. As another example, the information may suggest or instruct on how to advertise or display the product. Other examples of information include: product recall information; and/or product's age; and/or authenticity of product; and/or product ingredients; and/or use of product; and/or health and safety information; and/or product pairing; etc. Some of the information (e.g. authenticity of product or recall information) may be retrieved and verified before completion of a sale. In some embodiments, the information may be inventory information, e.g. the machine-readable code conveys a lot number, which allows for the retailer to use the machine-readable code to track how many of each lot the retailer has in stock.

In another aspect, systems/methods are provided that use a machine-readable code to retrieve information specific to a cannabis product for use by a consumer or potential consumer. Examples of such information may include: authenticity of the product; and/or product information such as a Certificate of Analysis; and/or product pairings; and/or health and safety information; and/or recommendations for alternative products; etc.

### BRIEF DESCRIPTION OF THE DRAWINGS

Embodiments will be described, by way of example only, with reference to the accompanying figures wherein:

FIG. 1 illustrates a system for utilizing a machine-readable code on a cannabis product, according to one embodiment;

FIG. 2 illustrates example formats of a machine-readable code;

FIG. 3 illustrates a block diagram of an electronic device, according to one embodiment;

FIG. 4 illustrates a system for electronic feedback for a cannabis product, according to one embodiment;

FIG. 5, consisting of FIGS. 5A and 5B, illustrates a flow chart of a method performed by the electronic device, according to one embodiment;

FIG. 6 illustrates examples of input objects on a graphical user interface (GUI) that may be selected in the context of specific feedback questions;

FIG. 7 illustrates a variation of FIG. 4 in which electronic feedback is received from multiple electronic devices;

FIG. 8 illustrates a variation of FIG. 4 in which a lot is processed to produce two different types of cannabis products;

FIG. 9 illustrates a system for electronic feedback for cannabis products originating from different cannabis producers, according to one embodiment;

FIG. 10 consisting of FIGS. 10A and 10E, illustrates a flow chart of a method performed by an electronic device and network, according to one embodiment;

FIG. 11 illustrates a variation of FIG. 4 in which electronic feedback is also transmitted from an electronic device of the retail store;

FIG. 12 illustrates a system for authenticating a cannabis product, according to one embodiment;

FIG. 13 illustrates a system for retrieving information for cannabis products, according to one embodiment;

FIG. 14 illustrates an example of a format of a machine-readable code and its use amongst different units of a cannabis product;

FIG. 15 illustrates operation of a machine for generating labels, according to one embodiment;

FIG. 16 illustrates an example of inventory tracking, according to one embodiment; and

FIG. 17 illustrates a system for electronic feedback that is agnostic of the cannabis producer, according to one embodiment.

### DETAILED DESCRIPTION

For illustrative purposes, specific embodiments and examples will be explained in greater detail below in conjunction with the figures.

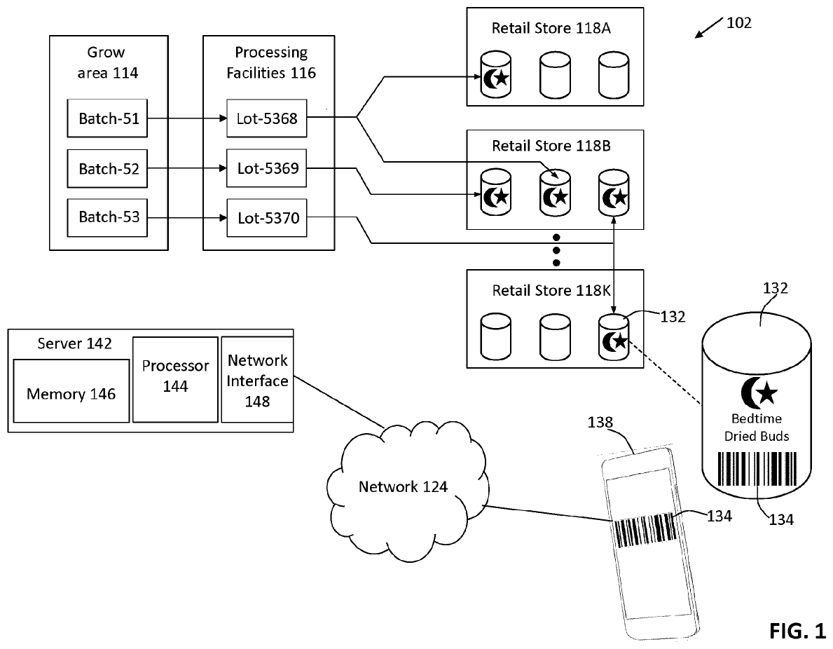

FIG. 1 illustrates a system 102 for utilizing a machine-readable code 134 (e.g. a barcode) on a cannabis product, according to one embodiment.

Cannabis plants are cultivated and harvested in a grow area 114. Each batch of cannabis plants is assigned a respective unique identifier (ID), which will be referred to as a batch number, e.g. Batch-51, Batch-52, Batch-53, etc. Harvested batches are processed in processing facilities 116 to produce “lots” of cannabis products. Each lot is assigned a respective unique ID, e.g. Lot-5368, Lot-5369, Lot-5370, etc. The unique lot ID is typically a number, and so will be referred to as a lot number. In general, the number may include alphabetic and/or numeric characters.

In general, one batch may produce multiple lots even though FIG. 1 only illustrates one lot per batch. Also, all the cannabis in a lot typically originates from the same batch, although this is not necessary in all embodiments.

In some embodiments, lots may be assigned as follows: all units of a particular cannabis product (e.g. “Bedtime” dried buds) originating from a same batch are assigned the same lot number; a different cannabis product (e.g. “After dinner” dried buds) from that same batch is assigned a different lot number; and any product originating from a different batch is assigned a different lot number.

Retail stores 118A-K sell the cannabis products. Each unit of cannabis product includes a machine-readable code 134. The machine-readable code 134 is used as part of a method during which information is sent to a server 142 and/or received from the server 142 over a network 124 (e.g. the Internet). The server 142 includes a network interface 148, a processor 144, and a memory 146. The processor 144 may be implemented by one or more processors that execute instructions stored in the memory 146. The instructions, when executed, cause the processor 144 to perform server-side operations described herein. Alternatively, some or all of the processor 144 may be implemented using dedicated circuitry, such as an application specific integrated circuit (ASIC), a graphics processing unit (GPU), or a programmed field programmable gate array (FPGA) for performing the operations of the processor 144.

During operation, several batches of cannabis plants are cultivated and harvested over time. Some batches may be cultivated and harvested in parallel. These batches are processed into finished goods lots. In particular, the harvested plants of each batch are processed in processing facilities 116 to produce units of cannabis products that can be sold. The processing performed depends upon the cannabis product lots being produced. In some scenarios, the whole batch of plants is processed in the same way to produce units of cannabis products that may be sold under the same lot and brand. However, in general this need not be the case. For example, different plants in the same batch (or even different buds of a same plant in a same batch) could be processed in different ways to produce different types of cannabis products sold under different brands. These would produce different lots of finished goods (cannabis products). For example, a batch may yield 13,000 harvested plants. Some of the plants may be dried and sold as one lot of units of dried buds under one brand (e.g. “Bedtime” dried buds lot-100), others of the plants may also be dried and sold as another lot of units of dried buds under a different brand (e.g. “After dinner” dried buds lot-101), others of the plants may have their dried buds milled and incorporated into a different line of cannabis products, e.g. oral capsules, (e.g. milled cannabis lot-102) and other of the plants may have their buds processed to produce a concentrate that is incorporated into yet a different line of cannabis products, (e.g. cannabis oil lot-103). However, all of the cannabis present in a unit of cannabis product originates from the same batch.

In the examples described in relation to FIG. 1, it will be assumed that for a plurality of batches including batches 51, 52, and 53, all of the plants of each batch are processed in the same way and sold under the same brand, which in this example will be “Bedtime” dried buds. A separate lot number is assigned to each batch, e.g. units of “Bedtime” dried buds originating from batch 51 are assigned lot number 5368, units of “Bedtime” dried buds originating from batch 52 are assigned lot number 5369, and units of “Bedtime” dried buds originating from batch 53 are assigned lot number 5370. Other variations are described later.

Each unit of cannabis product is made available for sale at a retail store. A retail store may be a physical store (“bricks and mortar”), an online store, a store that operates by mail order, a store that operates by telephone order, etc. A retail store may or may not be associated with the cannabis producer. A retail store may sometimes be referred to as a dispensary. Each unit of cannabis product typically includes a container in which cannabis is contained, e.g. container 132. The word “container”, as used herein, encompasses any item in which cannabis is contained. For example, the container may be a bottle or jar in the case of dried buds, the container may be a drink bottle in the case of a cannabis-infused drink, the container may be a box in the case of an edible, the container may be a cannabis accessory if the cannabis accessory contains cannabis when sold, etc. The container may include packaging and/or labels. An information sheet or sheets may be included within the container or accompany the container.

Different units of cannabis products from the same lot and batch may be sold in different retail stores. For example, FIG. 1 illustrates containers of “Bedtime” brand dried buds identified using a moon and star. Units belonging to lot 5368 are sold in retail stores 118A and 118B. Units belonging to lot 5369 are sold in retail store 118B, and units belonging to lot 5370 are sold in retail stores 118B and 118K.

Each unit of cannabis product includes a machine-readable code 134. The machine-readable code 134 is illustrated in FIG. 1 as a linear or one-dimensional bar code, but this is only an example. More generally, the machine-readable code 134 may be a machine-readable number or graphic, such as a barcode. A barcode encodes information in a visual pattern readable by a machine. A barcode may be linear or one-dimensional, e.g. as in the example illustrated in FIG. 1. Alternatively, a barcode may be a matrix barcode or two-dimensional, e.g. a QR code.

In one embodiment, the machine-readable code 134 conveys (e.g. encodes) the lot number of the cannabis included in that unit of cannabis product. In most of the examples described herein, the lot number is the finest granularity at which a cannabis product can be identified, and the lot number is connected back to a particular batch of plants that has its own ID (e.g. Lot-5368 corresponds to Batch 51 in FIG. 1). The machine-readable code 134 therefore links a particular unit of cannabis product back to the lot of finished cannabis goods and to the batch of cannabis plants used to produce that unit of cannabis product. The machine-readable code 134 may be affixed on the container 132 in which the cannabis is contained (e.g. as illustrated in FIG. 1). Instead or also, the machine-readable code 134 may be included on packaging of the cannabis product, and/or on an information sheet included as part of the cannabis product, etc.

In some embodiments, the machine-readable code 134 may also uniquely identify plants within a batch. For example, in some embodiments, individual plants or pots may be assigned unique identifiers.

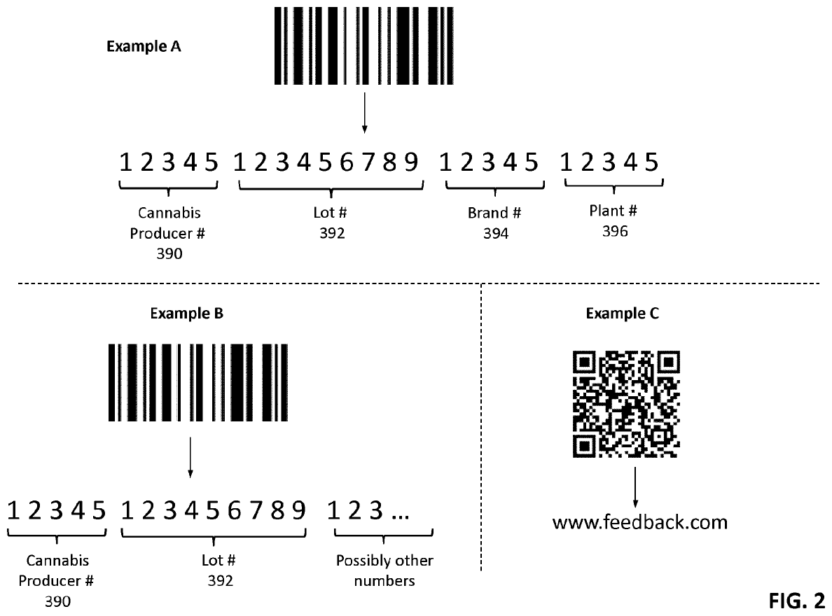

FIG. 2 illustrates three example formats of a machine-readable code 134. In Example A, the machine-readable code 134 is a linear barcode that encodes a number that includes a:
Cannabis producer number 390, which identifies the cannabis producer;
Lot number 392, which identifies the lot number of the product, and which links back to the batch the cannabis originated from in the unit of cannabis product;
Brand or product number 394, which identifies the type and/or brand of the cannabis product;
Plant number 396, which identifies the plant and/or plants and/or group of plants the cannabis originated from in the unit of cannabis product.

Not all of the information shown in Example A in FIG. 2 may be conveyed by the machine-readable code 134. For example, in some embodiments the plant number 396 may not be included. In some embodiments, it may not even make sense to include the plant number 396 if it is not known which exact plants in the batch are in the unit of cannabis product. As another example, in some embodiments the lot number 392 and the producer number 390 is encoded by the machine-readable code 134, as shown in Example B, but other information may not necessarily be present. In some embodiments, additional information may be included as part of the number conveyed by the machine-readable code 134, e.g. there may be digits reserved for future tracking use, for internal use by regulatory authorities, and/or for internal use by cannabis producers.

In some embodiments, the machine-readable code 134 may convey a Global Trade Item Number (GTIN), and the lot number may be part of the GTIN or encoded in the machine-readable code 134 in addition to the GTIN. For example, all units of the same cannabis product from the same producer may each include a barcode encoding the same GTIN corresponding to the product, but different lot numbers are assigned and also included as part of the barcode for different lots of the product. Example: the GTIN for “Bedtime” dried buds is 4069123456789; a lot of “Bedtime” dried buds originating from batch 51 is assigned lot number 5368, and each unit of “Bedtime” dried buds in lot number 5368 has the same barcode, which encodes the following: 4069123456789 5368; a lot of “Bedtime” dried buds originating from batch 52 is assigned lot number 5369, and each unit of “Bedtime” dried buds in lot number 5369 has the same barcode, which encodes the following: 4069123456789 5369; etc.

In some embodiments, the machine-readable code 134 may be a QR code that conveys additional or different information, e.g. a uniform resource locator (URL). The URL may be used to navigate to a website hosted by a server (e.g. server 142), and the website may provide information related to the cannabis product. Example C of FIG. 2 illustrates a QR code.

In some embodiments, the machine-readable code 134 itself may convey other types of information different from that discussed above, e.g. manufacture date of the unit of cannabis product, expiry or ‘best before’ date of product, etc.

Returning to FIG. 1, in operation the electronic device 138 processes (e.g. reads or decodes) the machine-readable code 134, and it is used for sending information to and/or receiving information from the server 142, e.g. as per the various embodiments described below.

The electronic device 138 illustrated in FIG. 1 is a mobile phone, but this is only an example. Another type of electronic device may be used instead, e.g. tablet, laptop computer, desktop computer, any internet-connected device with a camera or barcode scanner, such as a point-of-sale (POS) device, cash register, music player, etc.

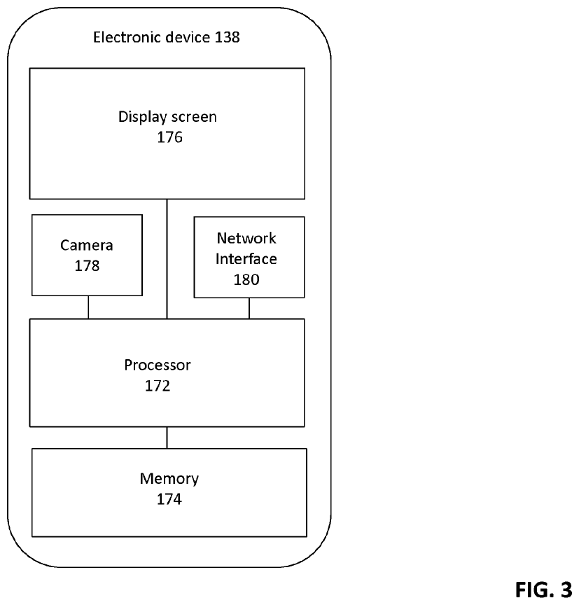

FIG. 3 illustrates a block diagram of electronic device 138, according to one embodiment. The electronic device 138 includes a processor 172, a memory 174, a display 176, a camera 178, and a network interface 180. The electronic device 138 may include other components, but these have been omitted for the sake of clarity. In operation, the processor 172 controls the electronic device 138 to perform the operations of the electronic device 138 described herein. The processor 172 may be implemented by one or more processors that execute instructions stored in memory 174. The instructions, when executed, cause the processor 172 to perform the operations described herein. In some embodiments, the instructions may be part of a software application downloaded into memory 174 by the electronic device 134. Alternatively, some or all of the processor 172 may be implemented using dedicated circuitry, such as an ASIC, a GPU, or a programmed FPGA for performing the operations of the processor 172.

Feedback from the Electronic Device:

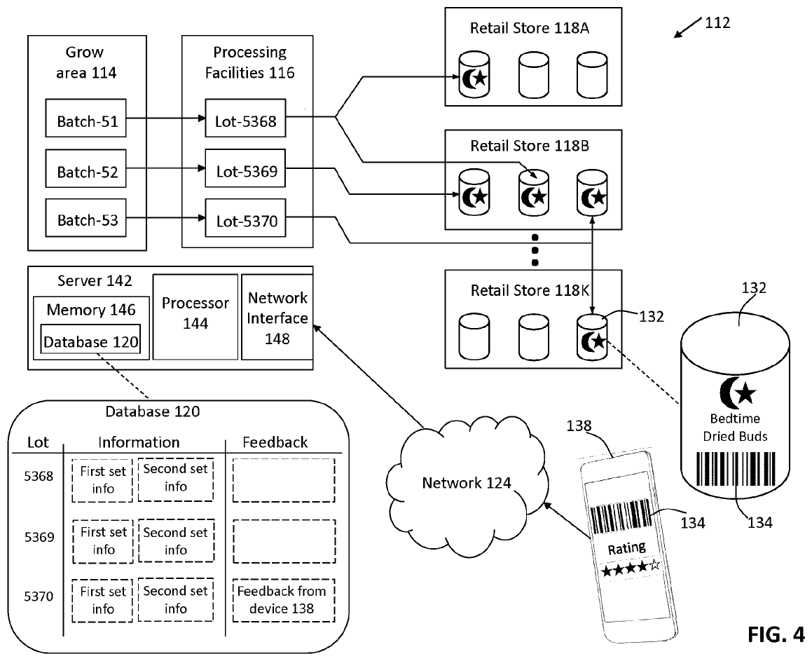

FIG. 4 illustrates a system 112 for electronic feedback for a unit of cannabis product, according to one embodiment. As used herein, the term “feedback” may encompass: (1) feedback entered into the electronic device 138 when the consumer reviews a unit of cannabis product, e.g. survey information completed by the consumer on their mobile device; and/or (2) feedback transmitted from the electronic device 138 that is not entered by the consumer in a review of a unit of cannabis product, e.g. IP address of the electronic device 138, GPS coordinates of the electronic device 138, time and/or date information, a sensor reading from the electronic device 138, information previously entered by a user (e.g. by the consumer) and stored in the memory of the electronic device 138 (such as age range and/or other personal information entered by the consumer), etc.

In FIG. 4, the server 142 is associated with the cannabis producer, and the server 142 includes or has access to a database 120. The database 120 stores information associated with each lot. The information may include a first set of information specific to the cultivation and/or harvesting of the batch corresponding to that lot, and/or a second set of information specific to the processing for that lot. For example, the first set information may originate from those responsible for growing and harvesting the batch corresponding to the lot, and the second set of information may originate from those responsible for processing harvested plants to produce the lot. Other information, such as the retail store at which each unit of cannabis product is shipped to for sale, customer account information, etc. may also be stored in database 120.

The following is a non-exhaustive list of information that may be included in the first set of information, i.e. in relation to the cultivation and/or harvesting of a batch of plants corresponding to one or more lots. Not every item listed below is necessarily applicable for a given batch.
origin of the seeds and/or rooted cuttings used to grow the batch;
storage location of the seeds and/or rooted cuttings used to grow the batch;
quantity of plants in the batch, possibly recorded at different points in time (e.g. number of plants at planting versus number of plants at harvesting);
quantity or percentage of plants that perished (process scraps) during the growing and/or harvesting process, possibly along with a record of when the plant perished and/or why/how it perished;
type, quantity, and/or composition of the growing medium;
type, quantity, composition, and/or application schedule of nutrients (e.g. fertilizer);
type, quantity, and/or schedule of lighting;
schedule of temperature and/or humidity;
type, quantity, and/or schedule of air ventilation;
quantity of watering and/or watering cycle;
quantity and/or percentage of plants that required special attention, possibly along with the details of the attention needed;
treatments performed on the plants;
root pH levels;
plants nutrients levels.

The following is a non-exhaustive list of information that may be included in the second set of information, i.e. in relation to the processing used to produce a lot. Not every item listed below is necessarily applicable for a given lot.
drying and/or curing process used;
drying and/or curing time;
type, quantity, and/or schedule of lighting during drying and/or curing;
schedule of temperature and/or humidity during drying and/or curing;
type, quantity, and/or schedule of air ventilation during drying and/or curing;
quantity and/or weight of cannabis included in a unit of cannabis product;
size, shape, colour, smell, texture, and/or dimension of the container for a unit of cannabis product;
type and/or quantity of other ingredients added, e.g. for flavour, fragrance, look, and/or texture;
extraction process used to produce a concentrate.

The database 120 also stores, for each lot, feedback in relation to a unit of cannabis product belonging to that lot. When a consumer purchases and consumes a particular unit of cannabis product, the consumer may use their electronic device 138 to read the machine-readable code 134 included as part of the unit of cannabis product. The machine-readable code 134 electronically links the unit of cannabis product to the lot number of the unit of cannabis product, which also links back to the batch of cannabis plants used to produce the unit of cannabis product. Feedback is transmitted from the electronic device 138, over the network 124, to the database 120 of the server 142 via the network interface 148. The feedback is electronically linked to the lot number (in this case lot 5370) identified by the machine-readable code 134. The feedback is then stored in memory of the database 120 in association with the lot number identified by the machine-readable code 134.

By using the system of FIG. 4, feedback in relation to a unit of cannabis product is electronically linked to the lot and therefore also back to the batch of plants (i.e. the batch-ID) used to actually produce that lot of cannabis product. This allows the cannabis producer to pull feedback from the database 120 that is matched to a specific batch, which may enable the cannabis producer to better evaluate the effect of variations between batches in cultivation, harvesting, and/or processing techniques. As one example, the plants of batch-53 may have a different watering schedule from the plants of batch-52. If units from lot 5370 of “Bedtime” brand cannabis product originating from batch 53 garner more positive feedback compared to units of lot 5369 of “Bedtime” brand cannabis product originating from batch 52, then it may suggest that the watering schedule used for the plants of batch-53 may produce cannabis having a more desirable effect to the consumer. As another example, when the plants of batch 52 are processed to produce “Bedtime” dried buds of lot 5369, the buds may be infused with chamomile originating from a conventional chamomile supplier, whereas when the plants of batch 53 are processed to produce “Bedtime” dried buds of lot 5370, the buds may be infused with chamomile originating from a more expensive premium chamomile supplier. If units of “Bedtime” brand cannabis product belonging to lots 5369 and 5370 receive comparable feedback, then it may suggest that using premium chamomile compared to conventional chamomile does not result in a discernable impact on the consumer's enjoyment of the product

In some embodiments, the electronic device 138 transmits feedback back to the database 120 only if the machine-readable code 134 is read by the electronic device 138. This authenticates that the feedback is associated with an actual possessed unit of cannabis product, which would eliminate ‘fake reviews’ submitted in the absence of possession of a unit of cannabis product.

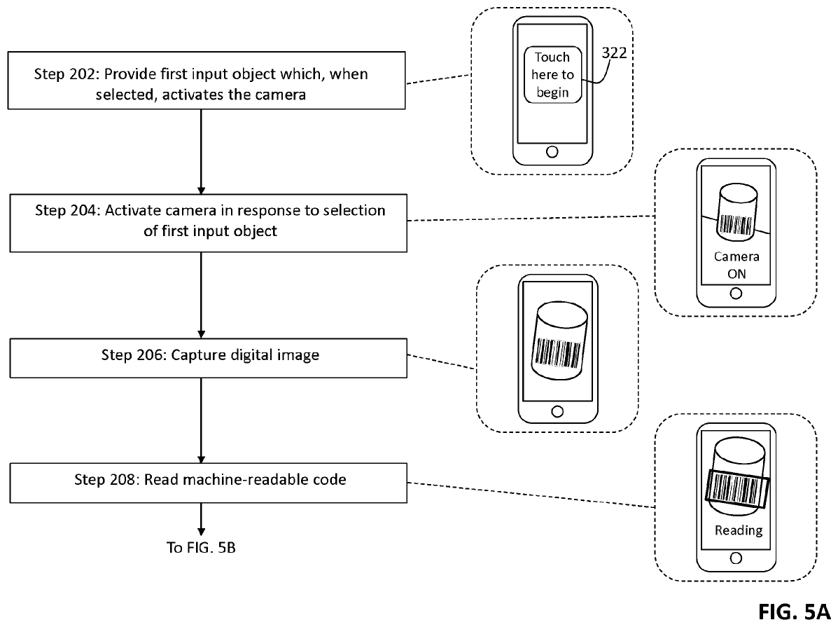

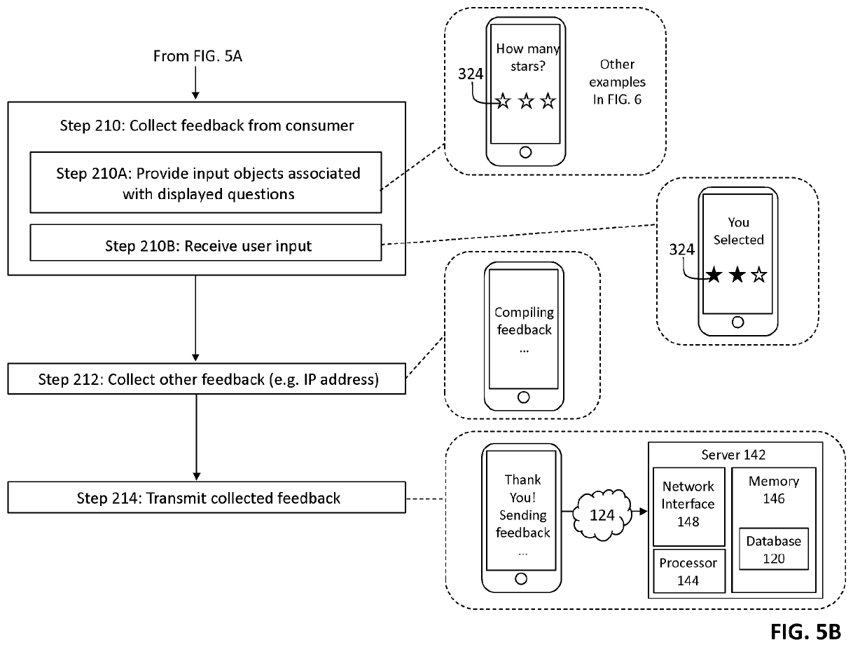

FIG. 5, consisting of FIGS. 5A and 5B, illustrates a flow chart of a method performed by the electronic device 138, according to one embodiment. In the method of FIG. 5, the processor 172 of the electronic device 138 implements a Graphical User Interface (GUI) on the display 176 of the electronic device 138, and so shown in stippled lines next to each box in the flow chart is an example of what may be displayed on the GUI during that step.

In step 202, the processor 172 causes the GUI to provide a first input object 322. The first input object 322, when selected by a user input, activates the camera 178. How the first input object 322 is selected by the user input depends upon the implementation, e.g. the user may select the first input object by touching the first input object 322 (for a touchscreen), or by using a mouse, or a keyboard, etc.

In step 204, in response to selection of the first input object 322, the processor 172 causes activation of the camera 178 so that the camera 178 can capture a digital photograph of the machine-readable code 134. The image viewed through the lens of the camera 178 may be displayed on the GUI on the display 176 in order to allow the user to line up the camera with the machine-readable code 134.

In step 206, the processor 172 instructs the camera 178 to capture a digital image (e.g. automatically upon identifying the machine-readable code 134 or upon receipt of a user input instructing the camera 178 to capture the digital image). The digital image captured by the camera 178 may be displayed on the GUI on the display 176.

In step 208, the processor 172 reads the machine-readable code 134 by processing the digital image of the machine-readable code 134 to obtain the information conveyed by the machine-readable code 134. The information conveyed by the machine-readable code 134 includes the lot number of the cannabis product, which can be linked to a batch of cannabis plants. If the machine-readable code 134 is a barcode, then the processor 172 may processes the digital image of the machine-readable code 134 by: (1) first performing barcode localization, i.e. searching the digital image to locate the barcode in the image; and (2) then performing barcode decoding, i.e. converting the barcode into the information contained in the barcode. Digital image processing techniques to perform barcode localization and barcode decoding are known in the art. For completeness, example methods for reading a barcode (e.g. barcode localization and barcode decoding) are disclosed in: “Research and Application of the EAN-13 Barcode Recognition on Iphone” by YeMin Li et al., published in 2010 in the 2010 International Conference on Future Information Technology and Management Engineering; and “An Introduction To QR Code Technology” by Sumit Tiwari, published in 2016 in the 2016 International Conference on Information Technology. See also “GS1 General Specifications: The foundational GS1 standard that defines how identification keys, data attributes and barcodes must be used in business applications” Release 18, published by GS1 in January 2018; and International Standard ISO/IEC 18004 “Information technology—Automatic identification and data capture techniques—Bar code symbology—QR code” published by ISO/IEC in 2000.

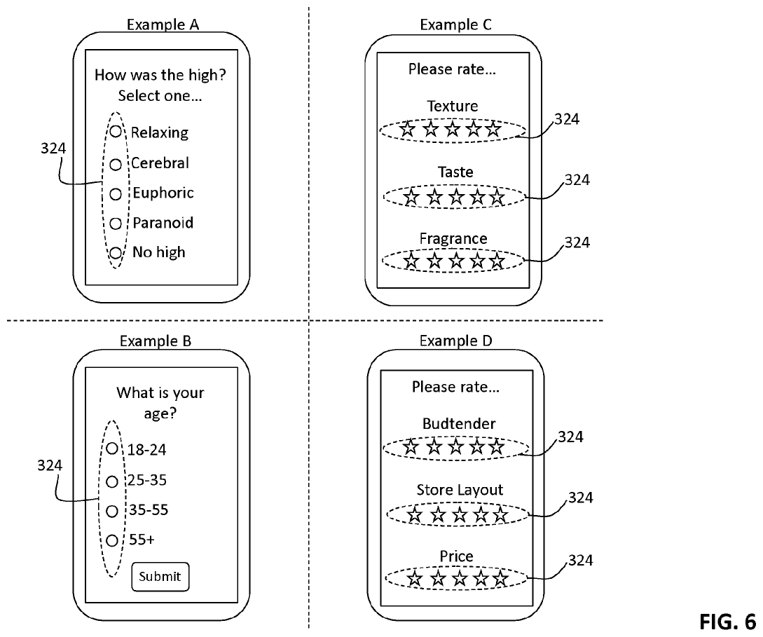

In step 210, the processor 172 collects feedback from the consumer via the electronic device 138. Step 210 includes steps 210A and 210B. In step 210A, the processor 172 causes the GUI to provide one or more input objects 324, which are associated with one or more questions displayed on the GUI and which, when selected provide a specific answer to the question(s). Examples of input objects 324 that may be selected in the context of specific questions are illustrated in FIG. 6. As shown in Example B of FIG. 6, the feedback does not necessarily have to relate to the consumer's experience of the specific cannabis product, but may comprise personal information provided by the consumer, e.g. age, income, sex, neighbourhood, employment status, relationship status, etc. As shown in Example D in FIG. 6, the feedback collected from the consumer in step 210 can also or instead relate to other aspects of the consumer's experience in relation to the unit of cannabis product, such as feedback on the price of the product and/or the service provided at the store at which the unit of cannabis product was purchased. In some embodiments, the feedback requested may be specific to the lot and/or batch, e.g. if a cultivation, harvesting, and/or processing technique was changed in relation to one lot or batch and the cannabis producer wants to request feedback specifically relating to that change for cannabis products from that lot and/or batch. If the feedback is specific to a batch, then the lot number is used to link back to that batch.

Returning to FIG. 5, in step 210B, a user input is received via one or more of the input objects 324, and the user input is stored in memory 174.

In step 212, the processor 172 collects feedback from the electronic device 138 that is not provided through the GUI in step 210 as part of a consumer review of the unit of cannabis product. The following is a non-exhaustive list of feedback that may be collected by the processor 172 in step 212. Some or all of the information below might not be collected, e.g. depending upon privacy law and/or user permission settings.
IP address of the electronic device;
GPS coordinates of the electronic device;
Age or age range of the consumer, e.g. which may have been entered by the consumer at an earlier time and stored in memory 174;
List of other cannabis products purchased and/or consumed, and/or frequency of such purchases, which may be collected over time and stored in memory 174;
General purchasing habits of consumer, which may be collected over time and stored in memory 174;
Frequented locations of electronic device, which may be collected over time and stored in memory 174;
Information from social media applications, such as identity of ‘friends’ and connections;
A unique customer account number, e.g. which may have been previously set up by the consumer and is stored in memory 174.
time and/or date information;
a sensor reading from the electronic device;
any other information previously entered by a user and stored in the memory 174 of the electronic device 138.

In step 214, the processor 172 causes automatic transmission of collected feedback through the network interface 180 to the database 120, via the network 124. The feedback is at least linked to the lot number obtained from the machine-readable code 134. For example, the feedback may be transmitted as a series of packets with a wrapper, where the wrapper associates the packets with each other and also with the lot number.

In some embodiments, step 208 is not performed by the processor 172 of the electronic device 138. Instead, the digital image captured by the camera 178 is transmitted back to the server 142 along with the collected feedback from step 210 and/or 212, and processor 144 at the server 142 performs step 208 to actually read the information conveyed by the machine-readable code 134. The feedback is still electronically linked to the lot because it is electronically linked to at least the image of the machine-readable code 134, which conveys the lot.

In some embodiments, step 210 or step 212 may be omitted. For example, the consumer may read the machine-readable code 134 using the electronic device 138 for reasons not relating to wanting to review the specific unit of cannabis product. For example, the consumer may read the machine-readable code 134 using the electronic device 138 to obtain additional information about the cannabis product, to collect loyalty points, to register the product, to unlock a security feature, etc. Steps 202 to 208 are therefore performed, but step 210 is omitted. However, step 212 may still be performed. The feedback in step 212 may still be useful to the cannabis producer, e.g. to allow the cannabis producer to learn about its market. For example, transmitting the general location of the electronic device's IP address may reveal that “Bedtime” dried buds are primarily consumed in a particular geographical area. This information may be pulled from the database 120 and used to present or pair the product in a way that is more desirable to people living in that geographical area.

Step 212 also helps solve another technical problem: extended electronic tracking of a cannabis product. In some regulatory environments it may be necessary or desirable to track the distribution of cannabis products, e.g. to track how many lots and/or units of each type of cannabis product are produced, which stores they are sold in, how many are sold, etc. However, tracking of a unit of cannabis product becomes a technical challenge once the unit of cannabis product is sold because it is now outside the distribution and retail infrastructure and into the hands of a private individual. Steps 202-208 and 212 provide a level of tracking of the unit of cannabis product after purchase by a private individual. The presence of the machine-readable code 134 included as part of the unit of cannabis product, allows the machine-readable code 134 to be read by the private individual's electronic device 138, and feedback relating to the private individual (e.g. age range, general location based on IP address, etc.) may be automatically collected by the electronic device 138 and transmitted to the server 142. This additional tracking information may be anonymized and used or reported, e.g. in accordance with industry regulations. This additional tracking information may be used to build consumer profiles in order to better understand the market of consumers purchasing products from the cannabis product producer.

In some embodiments, prior to steps 210 and/or step 212, the processor 172 implements an input object on the GUI that queries whether feedback is permitted to be collected and transmitted from the electronic device 138 to the database 120. Feedback is collected and transmitted to the database automatically, but only if the electronic device 138 receives a user input indicating that the user permits the feedback to be collected and transmitted.

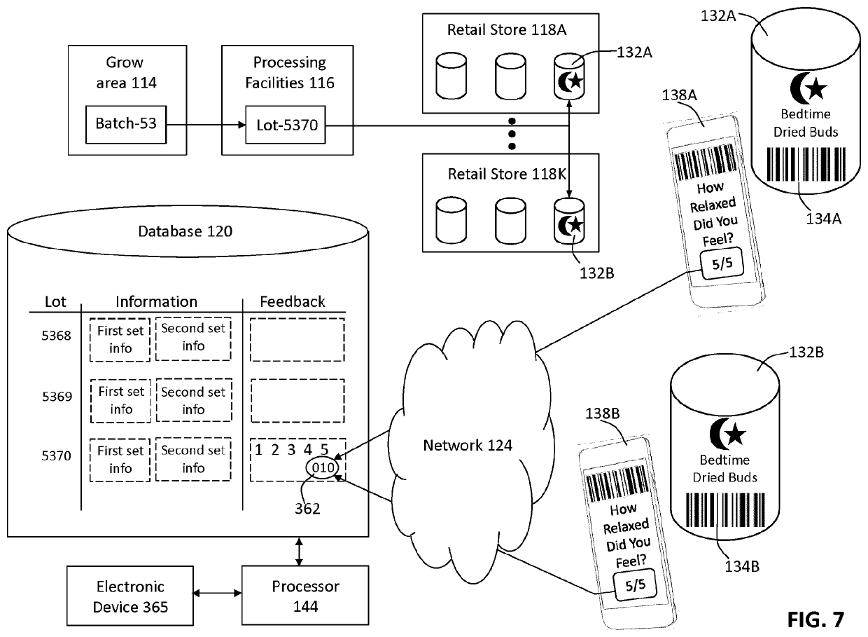

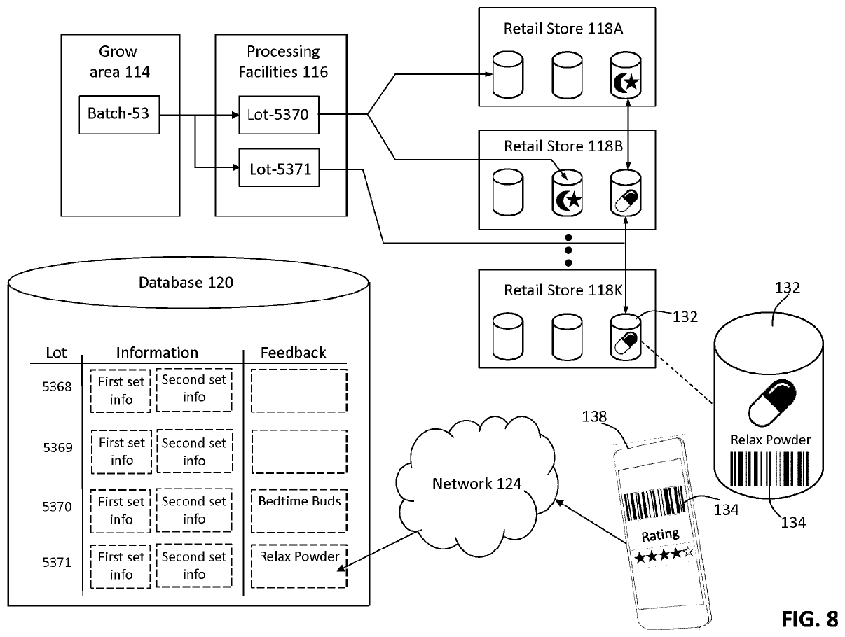

The electronic format of at least some of the feedback may be standardized to more easily allow for the accumulation and/or processing of feedback from multiple electronic devices. FIG. 7 illustrates a variation of FIG. 4 in which electronic feedback is received from multiple electronic devices 138A and 138B. Electronic device 138A is used to collect feedback relating to a first container 132A of lot 5370 “Bedtime” dried buds originating from batch-53. Electronic device 138B is used to collect feedback relating to a second container 132B of lot 5370 “Bedtime” dried buds also originating from batch-53. Container 132A may have been purchased from retail store 118A, and container 132B may have been purchased from retail store 118B. In the example in FIG. 7, each electronic device 138A and 138B collects the same feedback: 5/5, which is transmitted back to database 120 via network 124. Each instance of feedback increments the same counter associated with the 5/5 rating in the database 120. As shown at 362, the counter reads “two” (“010” in binary) because two ratings of 5/5 have been received, one from electronic device 138A and one from 138B. Storing the feedback in a standardized format, such as using counters, may allow for the feedback to be more easily retrieved and processed by the cannabis producer. For example, processor 144 in communication with the database 120 may automatically track the accumulated feedback and send a message to an electronic device 365 of a cannabis producer if the accumulated feedback becomes statistically significant and/or exceeds a certain threshold. For example, the processor 144 may automatically send the electronic device 365 a message if the “5/5” rating counter shown at 362 exceeds a certain threshold to indicate a lot that is experiencing success in the marketplace. The electronic device 365 may be any type of electronic device, e.g. a computer or a mobile device, such as electronic device 138 shown in FIG. 3 (but owned by, used by, or associated with a cannabis producer rather than a consumer).

The standardization of questions, along with answers of a fixed format, may also facilitate the standardization of language used to describe the effect of cannabis products. For example, two people experiencing the same effect may describe it using different words, e.g. “euphoric” vs. “amazing”. By using answers of a fixed format, the way an effect can be described may be standardized across different consumers, e.g. only include the word “euphoric” and do not include the word “amazing” as a selection possibility for describing a pleasing effect.

In embodiments described above, it is often assumed that the whole batch is processed to produce the same lot of cannabis product sold under the same brand, e.g. lot 5368 of “Bedtime” dried buds originating from batch 51. More generally, different plants in the same batch (or even different parts of a same plant in a same batch) could be processed in different ways to produce different types of cannabis product lots sold under different brands. FIG. 8 illustrates a variation of FIG. 4 in which Batch-53 is processed to produce a lot 5370 of dried buds sold under the brand name “Bedtime” dried buds, as well as a lot 5371 of fine milled cannabis in capsules sold under the brand name “Relax Powder”. In some embodiments, the machine-readable code 134 may not only convey the lot number, but also the type and/or brand of cannabis product, e.g. as described earlier.

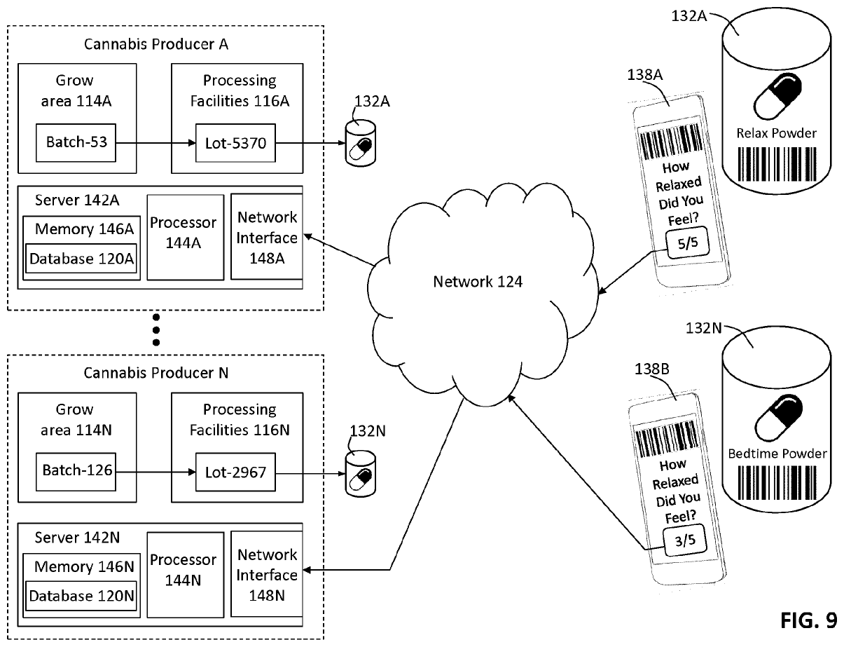

There may exist multiple cannabis producers, each selling cannabis products having a machine-readable code. For example, all cannabis products may need to include a machine-readable code, such as a barcode. In such a scenario, the following technical problem exists: how can the network 124 route the collected feedback and/or other messages from the electronic device 138 back to the intended cannabis producer. FIG. 9 illustrates a system for electronic feedback for cannabis products originating from different cannabis producers, according to one embodiment. A first cannabis producer, labelled as “cannabis producer A” is associated with a grow area 114A, processing facilities 116A, and a server 142A (having processor 144A, network interface 148A, and database 120A in memory 146A). A different cannabis producer, labelled as “cannabis producer N” is associated with a grow area 114N, processing facilities 116N, and a server 142N (having processor 144N, network interface 148N, and database 120N in memory 146N). FIG. 9 is a simplification. For example, in actual implementation the processing facilities 116A and 116N may be the same facility or facilities owned by a third party that has contracts with cannabis producers A and N to processes cannabis from both suppliers into cannabis products. A cannabis product 132A from lot 5730 and associated with cannabis producer A is sold, and feedback is collected from a first electronic device 138A belonging to a consumer. Another cannabis product 132N from a lot 2967 associated with cannabis producer N is sold, and feedback is collected from another electronic device 138B belonging to another consumer. A system is required to ensure that: the feedback collected from electronic device 138A in relation to cannabis product 132A is routed back to database 120A associated with cannabis producer A, and that the feedback collected from electronic device 138B in relation to cannabis product 132N is routed back to database 120N associated with cannabis producer N.

One solution is for each unit of cannabis product to include a machine-readable code that conveys information (e.g. a number) that uniquely identifies cannabis producer in the market. One way to achieve this is to assign each cannabis producer a unique ID that must be conveyed in the machine-readable code of each unit of cannabis product originating from that cannabis producer, e.g. cannabis producer number 390 in FIG. 2. Another way is to assign non-overlapping sets of lot numbers to each cannabis producer, such that a lot number conveyed in a machine-readable code has a one-to-one link back to a particular cannabis producer.

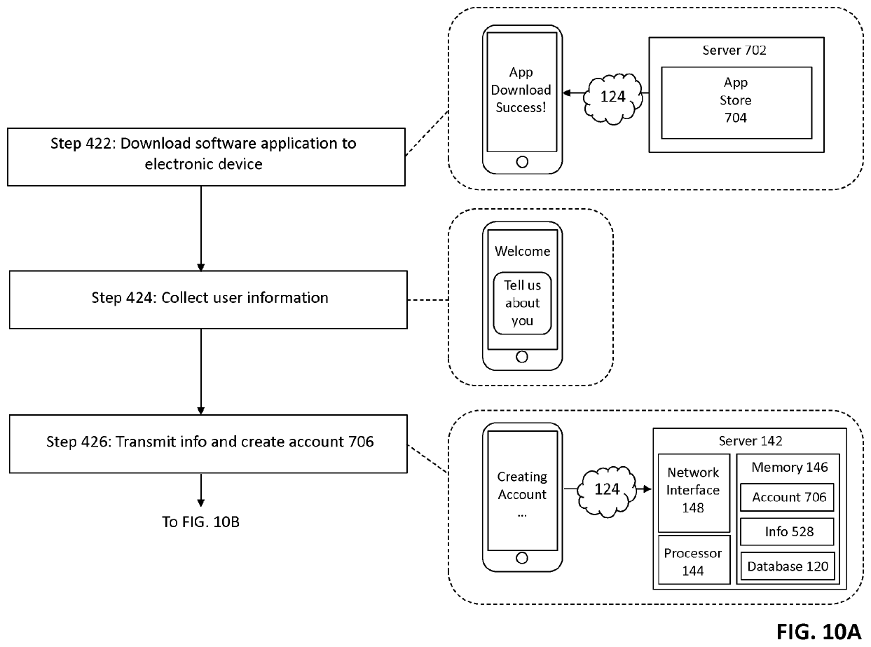

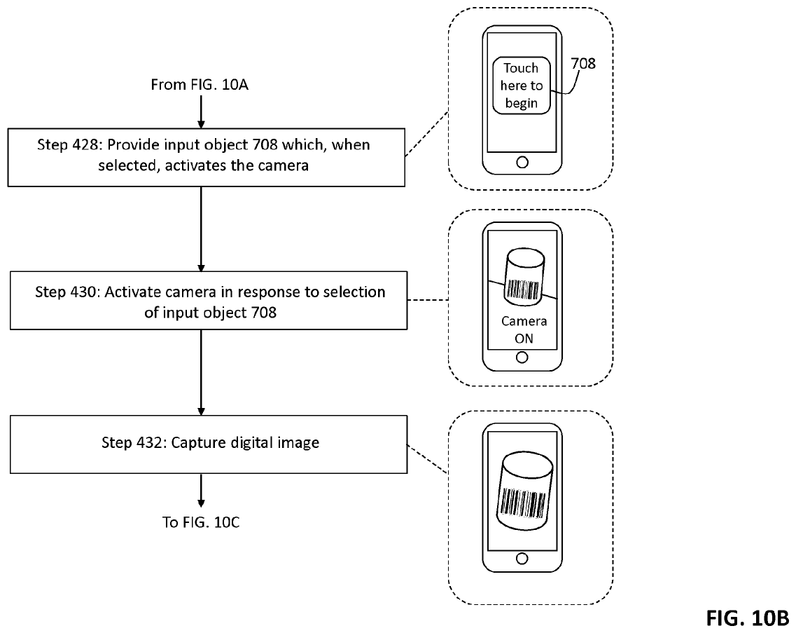

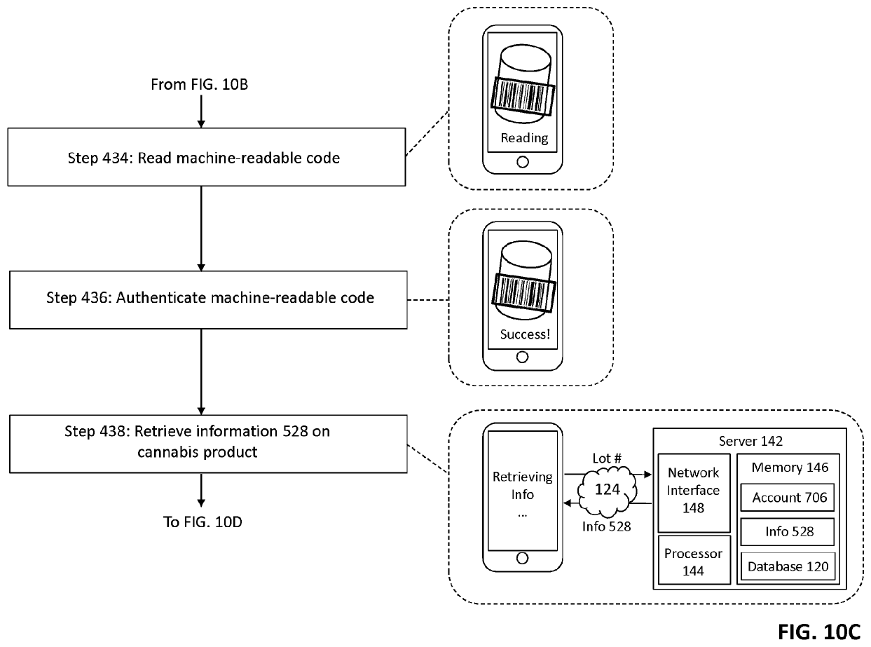

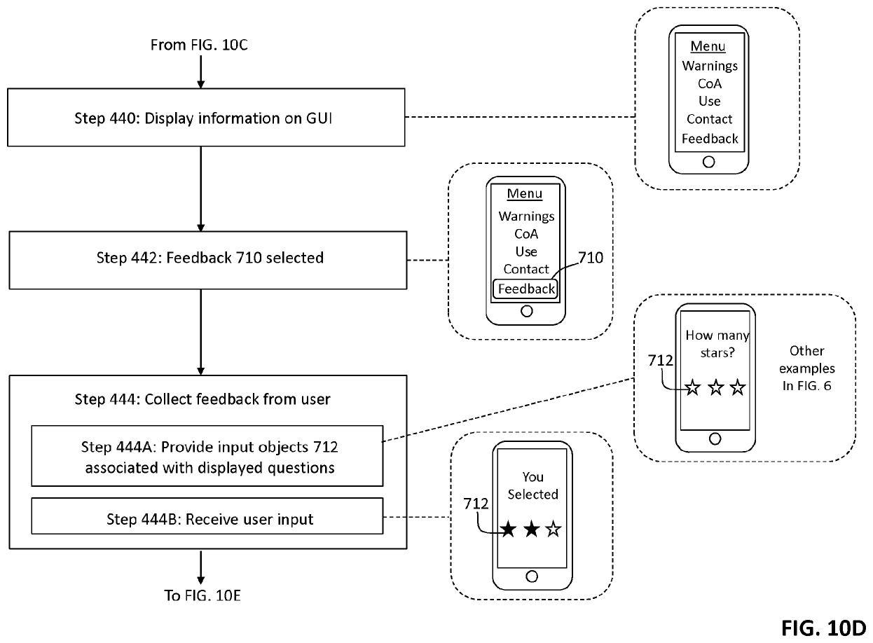

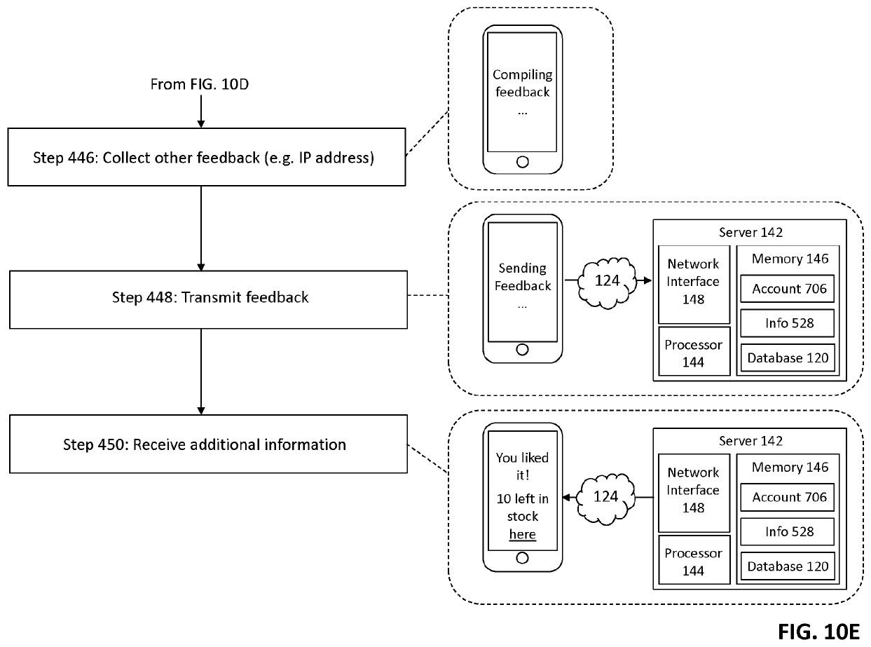

In some embodiments, a server in the network 124 may the receive feedback from the different electronic devices (e.g. electronic devices 138A and 138B) in relation to cannabis products originating from different cannabis producers. The feedback for each unit of cannabis product includes the machine-readable code of that cannabis product or includes the information conveyed by the machine-readable code. For each unit of cannabis product, the server identifies the cannabis producer from the information conveyed by the machine-readable code and forwards the feedback to the identified cannabis producer. In another embodiment, e.g. described as part of FIG. 10, a software application of the electronic device is associated with a cannabis producer and only collects and transmits feedback if the machine-readable code is recognized as belonging to that cannabis producer.

Feedback may be electronically linked in the database 120 to the type and/or brand and/or plant(s) via the machine-readable code 134. The granularity of the information conveyed by the machine-readable code 134 controls the granularity at which the feedback may be categorized.

It will be appreciated that a feedback system may be implemented in many different ways. The specific methods described above (e.g. FIG. 5) are all just examples. For completeness, a non-exhaustive list of possible ways in which the feedback system may be implemented is as follows.

### 1. Native Application Implementation:

A native application is a software application that needs to be installed on the electronic device 138. The application is specific to the operating system of the electronic device 138 and runs within that operating system. The application could be preinstalled, or downloaded from a digital distribution platform, e.g. an app store. An example is as follows: The consumer downloads the application from an app store. The consumer opens the application, and maybe creates an account, although creating an account may not be necessary. The consumer informs the application that he/she wants to provide feedback in relation to a cannabis product. The application activates the camera, a picture of the machine-readable code is taken, and the application reads the barcode to determine the lot number. The application collects the feedback. The application knows the IP address of the server 142. For example, a URL for a feedback site may be set when the application is written and included with the application code, or the machine-readable code may indicate the URL to use (e.g. if the machine-readable code was a QR code). The application transmits the feedback to the server 142.

One example method in the context of a native application implementation is described in FIG. 10. FIG. 10 consists of FIGS. 10A to 10E. In step 422, a software application is downloaded over the Internet 124 onto the electronic device 138, e.g. from app store 704 hosted on a server 702. The software application is executed by the processor 172 of the electronic device 138 to control the electronic device 138 to operate according to the following steps. In step 424, the electronic device 138 implements a GUI having input objects allowing the user to input information, e.g. to set up an account. The information may include user name and password and/or personal information (e.g. age range, sex, income range, etc.). In step 426, the information is transmitted to the server 142 over the Internet 124. The processor 144 at the server 142 uses the information to set up an account 706 for the user. In step 428 an input object 708 is provided on the GUI of the electronic device 138 which, when selected, activates the camera 178 of the electronic device 138. In step 430, the camera 178 is activated in response to selection of the input object 708, and a digital image of a machine-readable code from a cannabis product is captured in step 432. In step 434 the machine-readable code is read (e.g. decoded) and authenticated in step 436. The authentication in step 436 may comprise comparing the information conveyed by the machine-readable code to a list of valid possibilities currently used by the cannabis producer for their cannabis products on the market. This may be done on the electronic device 138 or by transmitting the machine-readable code (or information conveyed by a machine-readable code) to the server 142 where the comparison is performed and a result is returned to the electronic device 138.

Assuming authentication is successful, then in step 438 the lot number decoded from the machine-readable code is transmitted to the server 142 (if not already transmitted in step 436) and used to retrieve information 528 specific to that lot. Examples of information 528 stored in the memory 146 at the server 142 may include health warnings, product safety/use information, instructions for using the product, consumer information, cannabinoid profile, Certificate of Analysis (CoA) etc. The information 528 may be electronically linked to a lot number or other identifying information that is conveyed in the request. For example, the lot number conveyed in the request may be used by the processor 144 to retrieve from the memory 146 the information corresponding to that lot number.

The information 528 is transmitted back to the electronic device 138 and displayed on the GUI in step 440. In some embodiments, when the information 528 is displayed by the GUI, an input object 710 is provided that, when selected, allows the user to provide feedback in relation to a cannabis product.

In step 442, input object 710 is selected to submit feedback. In step 444, feedback is collected by displaying input object(s) 712 at the GUI (step 444A) and receiving user input (step 444B). In step 446, other feedback is collected by the electronic device 138 that is not input by a user and that is not specific to the cannabis product, but that may be of interest (e.g. IP address of electronic device, GPS coordinates of electronic device, time/date stamp, etc.). The feedback is transmitted to the server 142 in step 448. In exchange for providing the feedback, additional information may be transmitted from the server 142 to the electronic device 138, e.g. a product recommendation, a list of how many of the same or a similar product are still available for purchase, etc.

FIG. 10 is only an example, and not all steps are necessary. For example, one or some of steps 422, 424, 426, 436, 438, 440, 444/446, and 450 may be omitted.

In view of the above, in some embodiments a method performed by the electronic device may include: implementing a GUI on the electronic device that provides an input object that, when selected, activates a camera of the electronic device; acquiring a digital image using the camera, the digital image including a machine-readable code from a cannabis product; processing the digital image of the machine-readable code to obtain information conveyed by the machine-readable code; collecting feedback by the electronic device in relation to the cannabis product; and sending at least one transmission over a network, the at least one transmission including both the feedback and the information conveyed by the machine-readable code to electronically associate the feedback with the information conveyed by the machine-readable code. In some embodiments, the information conveyed by the machine-readable code uniquely identifies a group of cannabis plants (e.g. a batch) from which cannabis in the cannabis product originates. For example, the information conveyed by the machine-readable code may be a lot number, which links back to a specific batch of plants by being mapped to a particular batch ID. As another example, the information conveyed by the machine-readable code may be a batch number, which links back to a specific batch of plants.

In some embodiments, a method performed from the perspective of the network/server may include: receiving, from a first electronic device over a network, both: (i) first feedback that was collected by the first electronic device in relation to a first cannabis product, and (ii) first information that was obtained by the first electronic device from processing a digital image of a machine-readable code from the first cannabis product; receiving, from a second electronic device over the network, both: (i) second feedback that was collected by the second electronic device in relation to a second cannabis product, and (ii) second information that was obtained by the second electronic device from processing a digital image of a machine-readable code from the second cannabis product; storing the first feedback in memory in association with the first information, and storing the second feedback in memory in association with the second information.

2. Native Application Implementation with Picture Upload:

The native application implementation discussed above assumes the application on the electronic device 138 reads the machine-readable code and transmits, to the server, information conveyed by the machine-readable code. In alternative embodiments, the application on the electronic device 138 does not read the machine-readable code, but just causes transmission of the digital image of the machine-readable code to the server 142, and the processor 144 at the server 142 reads the machine-readable code.

In this variation, and in one embodiment, a method performed by the electronic device may include: implementing a GUI on the electronic device that provides an input object that, when selected, activates a camera of the electronic device; acquiring a digital image using the camera, the digital image including a machine-readable code from a cannabis product; collecting feedback by the electronic device in relation to the cannabis product; and sending at least one transmission over a network, the at least one transmission including both the feedback and the digital image to electronically associate the feedback with the digital image.

From the perspective of the network/server, in one embodiment the method includes: receiving, from an electronic device over a network, both: (i) feedback that was collected by the electronic device in relation to a cannabis product, and (ii) a digital image including a machine-readable code from the cannabis product; processing the digital image of the machine-readable code to obtain information conveyed by the machine-readable code; storing the feedback in memory in association with the information conveyed by the machine-readable code.

### 3. Web Application:

Alternatively, a web application may be used instead of a native application. A web application is a software application that does not need to be installed on the electronic device 138, but instead all of the necessary actions are managed through the browser of the electronic device 138. The application is basically a webpage hosted on the server 142 and appearing on/interacting with the consumer using the browser of the electronic device 138. There is no downloading the application via an app store.

As an example, the browser of the electronic device 138 navigates to a feedback site. The browser requests permission to open the camera 178 of the electronic device 138, and a digital image of the machine-readable code is captured. The browser uploads the digital image to the server 142 so that the processor 144 at the server 142 can read the machine-readable code. The processor 144 at the server 142 reads the machine-readable code and optionally checks that it is a valid code. The server 142 transmits a webpage to be displayed in the browser of the electronic device 138 to allow feedback to be collected. The consumer may input the feedback through the GUI presented by the browser, and the feedback is transmitted to the server 142. Additional feedback (e.g. IP address, location, etc.) may be collected by having the browser request permission and/or by backend analytics at the server 142. Collected feedback is stored at the server 142 (e.g. in database 120) in association with the information conveyed by the machine-readable code or the machine-readable code itself.

In some embodiments, from the perspective of the electronic device the following operations may be performed: receiving a message over a network from a server, the message requesting permission to activate a camera of the electronic device; activating the camera and acquiring a digital image using the camera, the digital image including a machine-readable code from a cannabis product; transmitting the digital image over the network to the server; receiving at least one message over the network, the at least one message soliciting feedback; in response to receipt of the at least one message, collecting the feedback in relation to the cannabis product; transmitting the feedback over the network to the server for storage in association with information conveyed by the machine-readable code.

In some embodiments, from the perspective of the server the following operations may be performed: transmitting a message over a network to an electronic device, the message requesting permission to activate a camera of the electronic device; receiving a digital image over the network from the electronic device, the digital image including a machine-readable code from a cannabis product; processing the digital image of the machine-readable code to obtain information conveyed by the machine-readable code; transmitting at least one message over the network to the electronic device, the at least one message soliciting feedback; receiving the feedback over the network from the electronic device; storing the feedback in memory in association with the information conveyed by the machine-readable code.

In some embodiments, the information conveyed by the machine-readable code uniquely identifies a group of cannabis plants (e.g. a batch) from which cannabis in the cannabis product originates. For example, the information conveyed by the machine-readable code may be a lot number, which links back to a specific batch of plants via a mapping between the lot number and a batch ID. As another example, the information conveyed by the machine-readable code may be a batch number, which links back to a specific batch of plants.

### 4. Third Party Barcode Reading Application:

In some implementations, a third party barcode reading application may be used. The machine-readable code (barcode) on the cannabis product may encode the URL of a feedback website, e.g. the barcode could be a QR code. An example is as follows: The user of the electronic device 138 scans a barcode on the cannabis produce using a third party barcode reading application. The third party barcode reading application may be a native application (e.g. a QR code reader included as part of the camera application), or the third party barcode reading application may be a third party web application (e.g. “barcodescanner.com”). The barcode encodes a URL for a feedback website. The URL may be unique to the lot number of the cannabis product, e.g. feedback.com/1134.html for lot number 1134, and feedback.com/1135.html for lot number 1135. The feedback would be transmitted to the same IP address, but different file paths (/1134 v. /1135) are indicated. Alternatively, the feedback website may be the same for all feedback in which case the barcode would also have to convey the lot number so that the lot number could be associated with the feedback. In any case, the browser of the electronic device 138 navigates to the URL indicated in the barcode, and the server hosting the webpage transmits the webpage to the electronic device 138 to be displayed, to allow the electronic device 138 to submit the feedback.

The four variations discussed in the example in the paragraph above are: (1) electronic device 138 reads barcode using native third party barcode reading application, and each lot number has its own URL; (2) electronic device 138 reads barcode using native third party barcode reading application, and barcode includes both the URL of a general feedback website and the lot number; (3) third party web application is used to read the barcode (e.g. picture of barcode is uploaded and barcode read on server), and each lot number has its own URL; (4) third party web application is used to read barcode (e.g. picture of barcode is uploaded and barcode read on server), and barcode includes both the URL of a general feedback website and the lot number.

If the electronic device reads the barcode using a native third party barcode reading application, then in one embodiment a method performed by the electronic device may include: implementing a GUI on the electronic device that provides an input object that, when selected, activates a camera of the electronic device; acquiring a digital image using the camera, the digital image including a machine-readable code from a cannabis product; processing the digital image of the machine-readable code to obtain information conveyed by the machine-readable code, the information including a URL; collecting feedback by the electronic device in relation to the cannabis product; and sending at least one transmission over a network to an IP address obtained from the URL, the at least one transmission including the feedback.

If the electronic device reads the barcode using a third party barcode reading web application, then in one embodiment a method performed by the electronic device may include: receiving a message over a network, the message requesting permission to activate a camera of the electronic device; activating the camera and acquiring a digital image using the camera, the digital image including a machine-readable code from a cannabis product; transmitting the digital image over the network; receiving a message over the network, the message including a URL that was obtained from the digital image; collecting feedback by the electronic device in relation to the cannabis product; and sending at least one transmission over a network to an IP address obtained from the URL, the at least one transmission including the feedback.

If each lot has its own URL, then in one embodiment a method performed by a server may include hosting a plurality of webpages on at least one server, each webpage having a URL corresponding to a respective lot. In this way, each webpage URL also corresponds to a respective group of cannabis plants (which may be the same group, e.g. same batch, for the case in which different lots come from the same batch). The method may further include receiving, over a network, first feedback that was collected by a first electronic device in relation to a first cannabis product, the first feedback sent to a first URL; receiving, over the network, second feedback that was collected by a second electronic device in relation to a second cannabis product, the second feedback sent to a second URL; storing the first feedback in association with an identifier of a first lot corresponding to the first URL, and storing the second feedback in association with an identifier of a second lot corresponding to the second URL. The first and second lots each correspond to a respective group of cannabis plants. The respective groups may be the same group if the first and second lot happen to originate from the same batch.

If all feedback is sent to the same URL, then in one embodiment a method performed by a server may include: receiving, from a first electronic device over a network, both: (i) first feedback that was collected by the first electronic device in relation to a first cannabis product, and (ii) first information that was obtained from a digital image of a machine-readable code from the first cannabis product; receiving, from a second electronic device over the network, both: (i) second feedback that was collected by the second electronic device in relation to a second cannabis product, and (ii) second information that was obtained from a digital image of a machine-readable code from the second cannabis product; storing the first feedback in memory in association with the first information, and storing the second feedback in memory in association with the second information.

### 5. Hybrid Application Implementation:

In another variation, a hybrid application is used to implement the feedback collection. A hybrid application is a web application disguised as a native application. For example, a native application may be downloaded to the electronic device 138 from an app store, but the downloaded native application is essentially a “shell” that points to the address of the web application. The methods performed by the electronic device and server discussed above in relation to the web application implementation very much apply to a hybrid application implementation also.

Feedback from a Retailer:

Many of the embodiments described above assume that the feedback originates from electronic devices associated with consumers. However, in some embodiments the feedback may also or instead be transmitted from a device associated with the retail store back to the database 120 over the network 124. As mentioned earlier, a retail store may be a physical store (“bricks and mortar”), an online store, a store that operates by mail order, a store that operates by telephone order, etc.

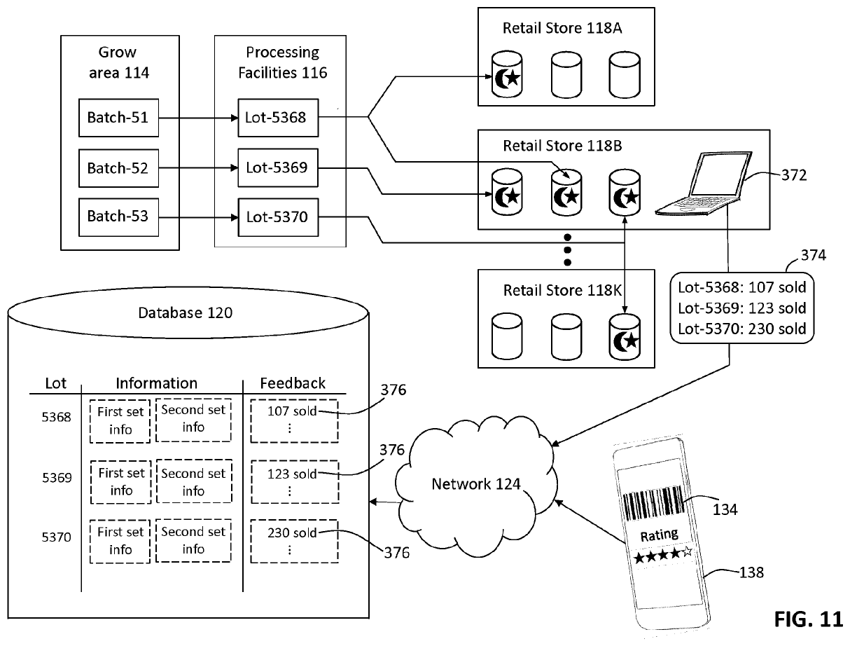

FIG. 11 illustrates a variation of FIG. 4 in which electronic feedback is also transmitted from an electronic device 372 of retail store 118B to database 120 via the network 124. The electronic device 372 is illustrated as a laptop, but another type of electronic device may be used instead, e.g. tablet, desktop computer, sales terminal, internet-connected device, etc. Without losing generality, in some embodiments below the electronic device 372 will be referred to as computer 372.

The feedback from electronic device 372 may also be electronically linked to specific lot numbers. For example, electronic device 372 may be a computer used by the retail store 118B to track inventory and sales. When a unit of cannabis product is sold, the machine-readable code 134 of the sold unit of cannabis product is read and stored in memory of the electronic device 372 (or in remote memory accessible by the electronic device 372), and used to update the inventory for that product. In this way, the number of units sold from each lot may be tracked. The feedback from electronic device 372 may include a list of all units of cannabis product sold by the retail store 118B over a given time period, e.g. per month. The feedback may indicate how many units from each lot are sold during the given time period, e.g. as shown at 374. The feedback may be stored in database 120, e.g. as illustrated at 376.

The following is a non-exhaustive list of feedback that may be collected by a retail store, e.g. by electronic device 372 at retail store 118B. Some or all of the information below might not be collected, e.g. depending upon privacy law and/or permission of the consumer.
number of units sold, and possibly the number of units sold from each lot and/or each brand;
date and/or time of sale, which may be retrieved from the sales terminal at the time the machine-readable code 134 is read;
feedback entered by employees or owners of the store in relation to the sale, e.g. whether the product is garnering a lot of interest or questions;
information obtained from the customer during the purchase and entered into the electronic device, e.g. the purchaser's postal code, mobile number, age, etc.
name and/or ID of customer service representative (“budtender”) who conducted the sale of the unit of cannabis product.

### Use of Feedback:

As described in some embodiments above, the feedback associated with a consumer and/or retail store may be used by a producer of cannabis and/or a producer of cannabis products. For completeness, a non-exhaustive list follows of example ways in which feedback from consumer electronic devices (e.g. device 138) and/or from the retail store devices may be used. Only one or some of the uses contemplated below may be implemented in some embodiments.

1. Varying Cultivation, Harvesting, and/or Processing Techniques

In some embodiments, the feedback is electronically linked back to the batch of plants used to actually produce that unit of cannabis product, e.g. the lot number encoded in the barcode of the unit of cannabis product is linked back to the batch ID of the batch of plants used to produce the lot. This allows the cannabis producer to pull feedback from the database 120 that is matched to a specific lot and connected to a specific batch of plants, which may enable the cannabis producer to better evaluate the effect of variations between batches and/or lots in cultivation, harvesting, and/or processing techniques. For example, a cultivation, harvesting, and/or processing technique may be modified for one or some of the batches. Then, depending upon the feedback received in relation to the modified finished goods lot(s), the modified cultivation, harvesting, and/or processing technique may be propagated to other lots or further modified. As an example, a particular terpene profile and/or cannabinoid level may be used for a particular cannabis product lot. When a consumer's electronic device reads a barcode corresponding to that lot, feedback is requested. The feedback may be specific to the lot, e.g. rating the effect in relation to the terpene profile and/or cannabinoid level. Depending upon the aggregated feedback from multiple devices in relation to that lot, the cannabis producer can decide whether to also use that terpene profile and/or cannabinoid level for other lots, or try changing the terpene profile and/or cannabinoid level, or not use that terpene profile and/or cannabinoid level for other lots. Feedback from the retail stores (e.g. number of sales) may also or instead be used to gauge consumer desirability.

Other cultivation, harvesting, and/or processing techniques are detailed below, with reference to exemplary process for producing cannabis products in accordance with one non-limiting embodiment. The process may comprise a first step of cultivating a batch of cannabis plants. The batch of cannabis plants may be cultivated in a grow area, the grow area being defined as an area of a given surface area that is being used to cultivate the cannabis plants of the batch. The grow area could be provided in greenhouses (i.e., in at least partially-sealed ambient environment structures) or in any other suitable structure that is conducive to the cultivation of cannabis plants. In some non-limiting examples, the grow area may be comprised of a plurality of sub-areas wherein the sub-areas are contiguous areas, but the sub-areas could also be non-contiguous (i.e., non-adjacent) in other non-limiting examples. That is, grow areas that include a plurality of non-adjacent areas are also possible. In other non-limiting examples, the greenhouse comprising the grow area may have a cultivation space of between about 5,000 square feet and about 1,000,000 square feet, however any other suitable dimension is possible in other non-limiting examples.

The cannabis plants of the batch of cannabis plants cultivated in the grow area may be from the same type of seeds or from the same mother plant, a mother plant being defined as a plant grown for the purpose of taking cuttings or offsets in order to grow more of the same plant. In other non-limiting examples, the grow area may be used to cultivate cannabis plants from a plurality of different seed types and/or a plurality of different mother plants.

It is appreciated that the cultivating may consist of a variety of distinct stages of development of cannabis plants. Without wishing to be bound by any theory, such stages may notably include the germination phase, the seedling phase, the vegetative phase and the flowering phase. Each one of those stages may be triggered and/or supported and/or terminated by various cultivation conditions, as further described below, such that the cultivation conditions need not be identical over the entire cultivation period of the cannabis plants. The cultivation period of the cannabis plants may be defined as the period starting from the beginning of the germination phase from seeds or the beginning of the cloning phase from cuttings up to the end of the flowering stage (i.e., pre-harvest stage), or as the period starting from the beginning of seedling phase up to the end of the flowering stage (i.e., pre-harvest stage), depending on the cultivation protocols chosen. Cuttings as used herein refers to any part of the plant, including but not limited to stems, stems including leaves, plant silk material, root material but not including rooting parts.

In some non-limiting embodiments, the abovementioned feedback can be used to identify an optimal harvest time at which the plants of the batch ought to be harvested so as to achieve consumer-desirable traits for the cannabis plants being harvested. In parallel, the abovementioned feedback can also be used to allow the cultivation conditions to be controlled within a grow area so as to provide uniform and/or optimized cultivation conditions during the cultivation period, or during a subset of the cultivation period, for all plants of the batch of cannabis plants within the grow area so as to achieve desirable traits for the cannabis plants being.

The cultivation conditions comprise various controllable cultivation parameters that can be organized as distinct cultivation regimen. It is appreciated that the cultivation parameters may be identical or substantially identical over an entire greenhouse (that is, over a plurality of distinct grow areas), or they may be different between distinct grow areas in other non-limiting examples. Furthermore, other controllable parameters of the cannabis products production process that are not specifically related to cultivating, and for example that relate to post-harvest processing, may also be controlled in other non-limiting examples. Any other suitable parameter relating to cannabis products production processes may be also controlled in other embodiments. In yet further non-limiting examples, a given set of controllable cultivation parameters may be specific to a batch of cannabis plants, to a strain of cannabis plant or both.

In a first non-limiting example, the cannabis plants within a specified grow area are exposed to light to sustain at least a vegetative phase and a flowering phase. A first set of controllable cultivation parameters may therefore be related to a lighting regimen of the cannabis plants during cultivating. Such lighting regimen comprises, but is not limited to, lighting parameters such as a lighting intensity (which may be normalized to a specified unit surface area), a lighting length of exposure, a lighting exposure cycle, a lighting spectrum, a lighting source and the likes. For example, the lighting regimen may comprise a specified lighting intensity that is applied over a pre-determined period of time which is repeated over a 24-hour time period, with or without alternating sources (i.e., natural, artificial). Since cannabis plants may also require, depending on their current growth phase, a pre-determined period of time over the course of a 24-hour period during which the cannabis plants are deprived or substantially deprived of light, it is appreciated that any controllable parameter relating directly or indirectly to light deprivation also falls within the scope of the lighting regimen above. For example, during the vegetative phase, a lighting regimen comprising 24-hours light cycles may be used to trigger root development during at least 3 weeks, while during the flowering phase a lighting regimen comprising 12-hours light cycles may be used during at least 6 to 8 weeks.

It will be readily appreciated that, in the context of cultivation performed in greenhouses, the lighting source may be natural (i.e., sun) and/or artificial (i.e., halogen lamps, etc.). As such, the lighting regimen discussed above may include both lighting from natural sources (natural lighting regimen) and artificial sources (artificial lighting regimen), the artificial lighting regimen being controllable and generally used to supplement the natural lighting regimen. As such, the artificial lighting regimen is reliant on the seasons during which cultivation occurs, with more supplementation being generally needed during winter to maintain a suitable lighting regimen, as further described below.

A single lighting regimen may be used over the entirety of the vegetative and flowering phases in some examples, however in other non-limiting examples, various lighting regimen may be used between the vegetative and flowering phases, or even between specific sub-phases of the vegetative and flowering phases. Similarly, a single lighting regimen may be used over the entire grow area or over the entire greenhouse, however in other non-limiting examples various lighting regimen may be used between specific sub-areas of a given grow area or between distinct grow areas of the greenhouse.

Any other cultivation regimen that is relevant to cannabis plants cultivation, as well as to cannabis products production generally, may also be used in other non-limiting examples such as, but not limited to, the temperature regimen (i.e., temperature and temperature cycle, etc.), the water irrigation regimen (i.e., overall water volume, water flow, water cycle, etc.), the humidity regimen (i.e., humidity and humidity cycle, etc.), the fertilizer regimen (type of fertilizer used, concentration and strength of fertilizer, fertilizer addition cycle, etc.), the carbon dioxide (CO₂) regimen (i.e., CO₂ amount and cycle, etc.), the air flow regimen (air flow cycle, etc.) and the likes. Any other suitable set of controllable parameters may be possible in other embodiments.

The cannabis plants in the batch are then harvested and then subjected to various post-harvest processing stages, as notably described in Canadian patents application nos. CA 3,048,298 and CA 3,033,404, the content of which is incorporated therein by reference. For example, cannabis plants harvested may be separated in distinct plant parts (e.g., flowers or buds, trims, etc.) and then subjected to a dehydration process. In the context of the present disclosure, dried cannabis plant parts, such as dried cannabis flowers, exhibit a moisture content of between about 10 wt % and about 15 wt %. Cannabis plant parts which have not been subjected to a dehydration process post-harvesting are referred to as fresh plant parts, such as fresh cannabis flowers, and exhibit a moisture content of between about 15 wt % and about 80 wt %

The timing of harvesting may or may not coincide with the beginning or the end of any one of the growth stages of the cannabis plants in the batch. The timing of harvesting may also be optimized using the various controllable cultivation parameters, as further described below. A plurality of different batches of cannabis plants may be cultivated and/or harvested in parallel or sequentially, each within distinct grow areas. For example, a greenhouse could be divided into a plurality of distinct grow areas, each grow area being used to cultivate a respective batch of cannabis plants. Each one of the batches of cannabis plants could then be used for producing different cannabis products. Multiple cannabis products could be produced from a single batch of cannabis plants. Different batches of cannabis plants could also or instead be combined to produce a single cannabis product.

In this non-limiting embodiment, various traits of the batch of cannabis plants being cultivated in the grow area, or the cannabis products obtained therefrom, may be dependent upon the controllable cultivation conditions described above. Said differently, the controllable cultivation conditions described above may be controlled such that various traits of the batch of cannabis plants being cultivated that are desirable (based on the above-mentioned feedback) may be obtained. These traits include, but are not limited to: an optimal harvest time of the cannabis plants, a plant mass, a plant density, a plant height, a quantity of total cannabinoids including but not limited to CBG and/or THC and/or CBD, a yield of THC and/or CBD per weight of the cannabis plants, a yield of cannabis plants per surface area of the grow area of the respective batch of cannabis plants, plant mass at harvest per overall irradiance during the cultivation period, CBG content during the cultivation cycle, yield THC/CBD per plant per overall irradiance over cultivation period, terpene profile, and the likes. These traits of the batch of cannabis plants may also be used to optimize and/or uniformize the cultivation of cannabis plants using consumer feedback.

2. Learning about the Consumer

As alluded to earlier, in some embodiments the feedback may be used to build consumer profiles in order to better understand the consumers purchasing products. For example, if the feedback included age range of the consumer, then different age-based consumer profiles may be generated and built/populated using the feedback from multiple consumers, e.g.:
Consumer Profile 1: “Age range 18-25”: 65% of our consumers are in this age range; 55% of the products they buy are cannabis-infused beverages; Brand “Happy Night” is the leading selling brand, . . .
Consumer Profile 2: “Age range 55+”: 10% of our consumers are in this age range; 70% of the products they buy are dried buds; . . .
Etc.
   3. Understanding and/or Tracking Use of the Product:

Many different variations are possible. For example, feedback relating to the location at which each product was purchased (e.g. from the retailer) and/or consumed (e.g. using GPS and/or IP address from consumer's device) may be used to understand which geographic areas are most popular for cannabis product sales. As another example, feedback relating to the consumer (e.g. age range, sex, other personal information) may be used to understand and track who is consuming cannabis products. As another example, sales feedback from retail stores may be used to track and understand factors such as: popularity of a particular cannabis product, sales comparison between different types of cannabis products, popular retail stores, popular retail store platforms (e.g. maybe more product is sold online compared to in a physical “bricks and mortar” store), etc.

### Authentication of a Cannabis Product:

In some embodiments, the machine-readable code 134 may be used to authenticate a cannabis product, e.g. to allow a check that the cannabis product is genuine, and to possibly retrieve product history (e.g. production/tracking/distribution information) for the product.

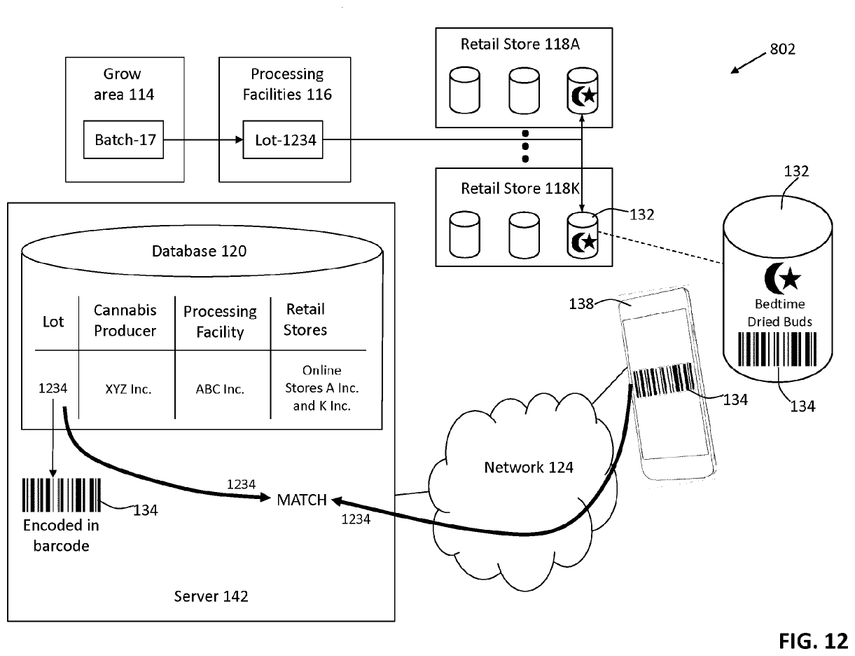

FIG. 12 illustrates a system 802 for authenticating a unit of cannabis product 132, according to one embodiment. A single lot (lot “1234”) is illustrated for simplicity. The lot 1234 corresponds to a particular product brand, e.g. “Bedtime” dried buds, and is produced from a batch 17 of plants, which is cultivated and harvested in grow area 114 and processed in processing facilities 116 to produce cannabis products. Retail stores 118A and 118K sell units of the “Bedtime” dried buds cannabis products from lot 1234. The lot number 1234 is encoded in the machine-readable code for each unit of “Bedtime” dried buds cannabis product having cannabis originating from batch 17. Database 120 may store information related to the lot, e.g. the identity of the cannabis producer and/or the identity of the processing facility and/or the identity of the retail stores in which the cannabis products from that lot are sold. An electronic device 138 may be used, e.g. by a consumer or potential consumer, to read the machine-readable code 134. In one embodiment, the machine-readable code 134 is decoded to obtain the lot number 1234, and the lot number is transmitted to the server 142 and compared to the lot numbers in database 120 to confirm that the lot number from the machine-readable code 134 matches a valid lot number in the database 120. Variations are possible depending upon the implementation. For example, a native application and/or web application may be used to implement the authentication process, e.g. the machine-readable code 134 may be read by the electronic device 138 (e.g. if native app) or by the server 142 (e.g. if picture of machine-readable code is uploaded to the server 142).

In some embodiments, each unit of cannabis product has a unique machine-readable code, in which case authentication may also comprise checking whether or not a unit of cannabis product having that machine-readable code has already been purchased. For example, after a retail store sells a cannabis product they may transmit the machine-readable code (or information conveyed by the machine-readable code) for the sold cannabis product to the server 142. The server 142 may keep an inventory of previously sold products. If a unit of cannabis product being authenticated by electronic device 138 has an invalid code or one that is not consistent with the inventory information, then the authentication may fail.

Upon authentication, in some embodiments information about the validity and/or history (e.g. production/tracking/distribution information) of the cannabis product may be transmitted back to the electronic device 138. Such information may be stored at server 142 and retrieved using the machine-readable code 134.

In some embodiments, the number of units of cannabis products associated with a particular batch, lot, and/or machine-readable code is stored in a database, and monitoring is performed to ensure that the number of products sold does not exceed the maximum number of cannabis products associated with that batch, lot, and/or machine-readable code. As an example, one thousand units of “Bedtime” dried buds may be produced for sale, each originating from the same batch and so each being assigned the same lot number, which is included in the barcode (e.g. a number encoded in the barcode that indicates the lot number, and possibly also indicates the cannabis producer and/or the product). Therefore, one thousand barcodes encoding the same unique number or combination of numbers (e.g. product number and lot number) are issued. Whenever a product from that lot is sold, an indication of the sale is recorded in a database (e.g. a counter in the database is incremented or decremented). If the number of products sold from the lot, as recorded in the database, exceeds the number of barcodes issued for that lot, then this indicates a problem. A message may be transmitted to the retailer and/or cannabis producer. This may trigger an investigation, e.g. it could be the case that black market product is being illegally sold using the barcodes issued for the legitimate product. In this way, the machine-readable code addresses the technical problem of how to use a machine-readable code and computer to identify illegal cannabis product.

### Distribution of Information for a Cannabis Product:

In some embodiments discussed above, the information conveyed by the machine-readable code 134 may be used to retrieve information specific to the cannabis product(s) associated with that machine-readable code 134. A cannabis producer may therefore use the machine-readable code 134 to facilitate transmitting information about a cannabis product from a database directly to intended recipients. For example, when the electronic device 138 transmits the information conveyed by the machine-readable code 134 (or a digital image of the machine-readable code 134) to the server 142, it acts as a request for the server 142 to retrieve information specific to the cannabis product(s) associated with that machine-readable code 134. For example, the machine-readable code 134 may encode the lot number associated with the cannabis product. The database 120 may store both the lot number and information specific to that lot. The lot number from the machine-readable code 134 is used to retrieve the information specific to the lot, and such information is then transmitted back to the electronic device 138. An example is shown earlier in steps 438 and 440 of FIG. 10, as well as in step 450 of FIG. 10. However, the retrieval of product-specific information does not have to be in the context of providing feedback. For example, a potential or intended consumer may use their mobile phone to read a machine-readable code on a cannabis product to retrieve the information to learn more about the product, and/or the retailer may read the machine-readable code on the cannabis product to retrieve information related to the cannabis product.

A non-exhaustive list of information that may be retrieved by a consumer or potential consumer of a cannabis product using the machine-readable code includes the following. Not every listed item is necessarily applicable or desirable:
Product information, such as a Certificate of Analysis (CoA) corresponding to the lot
Testing information, e.g. pesticide testing on the product;
Product use information;
Product safety information and/or health warnings;
Product history information, e.g. production/tracking/distribution information;
Information related to authenticity, genuineness, and/or validity of product;
Expiry or ‘best before’ information;
Information related to any recall associated with the product;
Recommendations for similar products, alternative products, and/or substitute pairings;
Inventory information, e.g. how many other products from the lot are available and at which retail stores;

### Use of the Machine-Readable Code to Assist the Retailer:

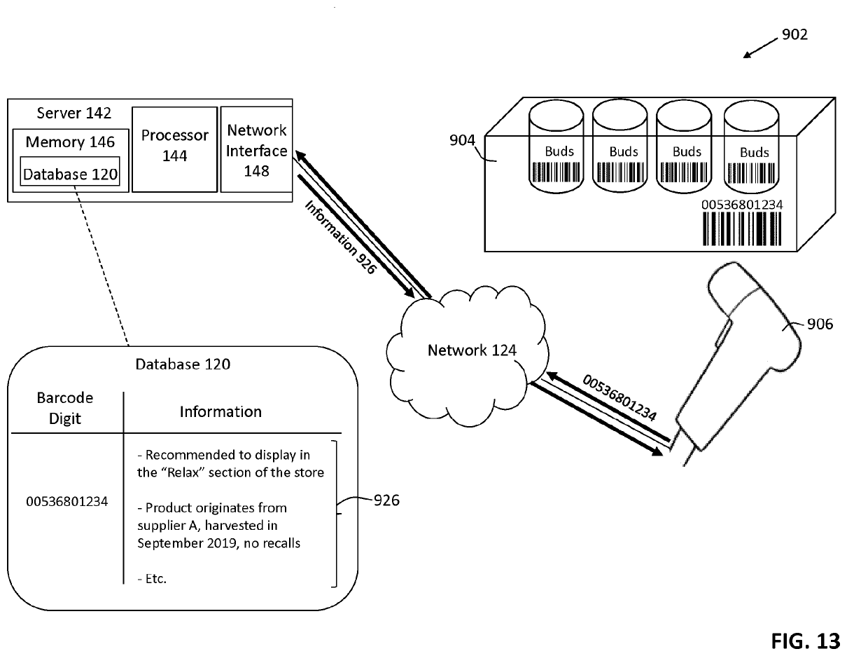

In some embodiments, the machine-readable code 134 may be used by retailers to retrieve information useful to the retailer in relation to a cannabis product. For example, FIG. 13 illustrates a system 902 for retrieving information for cannabis products, according to one embodiment. Cannabis products are stored at or arrive at a retailer, perhaps in storage or shipping container 904. Each cannabis product includes a machine-readable code. The storage or shipping container 904 may also include a copy of the machine-readable code of each product in the container 904. There may only be one machine-readable code on the container 904 if all cannabis products in the container 904 share the same machine-readable code (e.g. if all of the cannabis products are from the same lot). The machine-readable code encodes a number, e.g. “00536801234” in FIG. 13. An electronic device 906 is used to read the machine-readable code. The electronic device 906 is illustrated as a dedicated barcode scanner, but this is only an example. The electronic device 906 may be any internet-connected device with a camera or barcode scanner, e.g. a mobile phone, tablet, computer, POS device, cash register, etc. The electronic device 906 reads (e.g. decodes) the digits (“00536801234”) encoded by the machine-readable code and transmits a message including the digits to server 142. Alternatively, the electronic device 906 may send a picture of the machine-readable code to the server 142. The processor 144 at the server 142 retrieves information 926 from the database 120 corresponding to the digits conveyed by the machine-readable code, and the server 142 transmits a response including the information 926. A non-exhaustive list of information 926 that may be stored and retrieved includes the following. Not every listed item is necessarily applicable or included, depending upon the implementation:
Information providing a recommendation of where the cannabis product should be placed in the store or how it should be advertised (e.g. an information message stating “This product was formulated to try to produce a slight high with a relaxing effect. We recommend displaying this product in the ‘Relax’ section of the store”). In this way, the retailer may triage products using the machine-readable code.
Information to identify authenticity of the product. In some embodiments, the machine-readable code is scanned/read as part of the purchase transaction. The authenticity and validity of the product is checked at server 142 using the machine-readable code before the purchase can be completed. For example, if a particular lot or product is not authentic or can no longer be sold for some reason, then the check will fail.
Any information may be sent to the retailer that may also be of interest to the consumer, such as the examples listed earlier (e.g. CoA, product information, testing information, product use/safety/history, recommendations for similar products, alternative products, substitute pairings, inventory information, etc.).

The number encoded by the machine-readable code may be unique to the lot and/or unique to specific brands or product lines from the cannabis producer. In alternative embodiments, the machine-readable code may encode a URL directing the retailer's device to a webpage on which the information 926 may be found.

In view of the above, in one embodiment there is provided a method including: receiving a shipment of units of a first lot of a cannabis product, each unit of the first lot including a machine-readable code that conveys a lot number of the first lot; processing the machine-readable code to obtain the lot number; sending a transmission over a network that includes the lot number; in response to sending the transmission: receiving, over the network, information specific to the first lot. In another embodiment, there is provided a method including: receiving a shipment of units of a first lot of a cannabis product, each unit of the first lot including a machine-readable code that conveys a lot number of the first lot; acquiring a digital image of the machine-readable code; sending a transmission over a network that includes the digital image; in response to sending the transmission: receiving, over the network, information specific to the first lot. In these methods, the information may comprise one or more of: information providing a recommendation or suggestion of where the cannabis product should be placed in a retail store and/or how it should be advertised within the retail store; information that identifies authenticity of a unit of the first lot; product information; CoA; testing information; product use and/or product safety and/or product history; recommendations for similar products; recommendations for alternative or substitute products; inventory information. In these methods the lot number may be replaced with batch number instead.

More detail is provided later specifically in relation to use of the machine-readable code for inventory-related purposes.

### Provision and Application of Machine-Readable Code on Cannabis Products

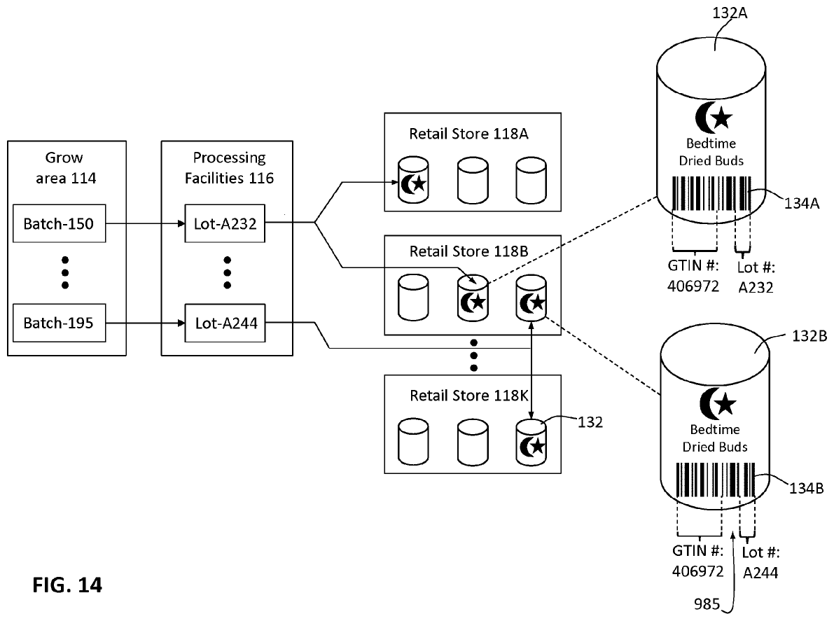

Examples of information possibly conveyed by the machine-readable code are discussed earlier, e.g. in relation to FIG. 2. A more specific example of a format of a machine-readable code and its use with different units of a cannabis product is now described in relation to FIG. 14. As shown in FIG. 14, two different batches (batch-150 and batch-195) are used to produce the same brand of cannabis product, which in this example is “Bedtime” dried buds. The machine-readable code affixed to each unit of “Bedtime” dried buds includes a component (e.g. a number) that is unique to “Bedtime” dried buds and that is the same for each unit of “Bedtime” dried buds, e.g. a Global Trade Item Number (GTIN), universal product code (UPC), or the like. FIG. 14 illustrates the machine-readable code as a linear barcode that encodes a GTIN. Of course, this is only an example. The number does not have to be a GTIN, and the machine-readable code does not have to be a linear barcode. The GTIN in this example is “406972”. The number 406972 is the same for each unit of “Bedtime” dried buds, regardless of the lot to which the unit of “Bedtime” dried buds belongs. The machine-readable code further includes a component (e.g. a number) that maps back to a batch of plants from which cannabis in the cannabis product originates, e.g. a batch number or lot number. In the example in FIG. 14 the machine-readable code encodes the lot number. Therefore, as illustrated in FIG. 14, unit 132A of “Bedtime” dried buds has a barcode 134A that conveys a number specific to the brand of cannabis product (the GTIN 406972) and a number that maps back to the batch of plants from which the cannabis in unit 132A originates (the lot #A232). Unit 132B of “Bedtime” dried buds has a barcode 134B that conveys the same number specific to the brand of cannabis product (the GTIN 406972) and a number that maps back to the batch of plants from which the cannabis in unit 132B originates (the lot #A244).

Therefore, information conveyed by the machine-readable code may possibly be different amongst different units of the same cannabis product (e.g. if the different units are from different lots). However, a technical benefit is provided: the computer processing the machine-readable code obtains lot and/or batch specific information which can be used by the computer to perform different actions discussed herein, e.g. link feedback to a lot, authenticate the product, obtain information relating to the lot, etc.

Note that a gap 985 is illustrated in FIG. 14 between the GTIN number and the lot number in barcodes 134A and 134B to indicate that, in general, the machine-readable code may possibly convey other information also, e.g. an expiry date. If an expiry date is conveyed, then different units and/or batches may have different expiry dates. For example, an expiry date may be the same for all units of a particular lot, but the expiry date of one lot may be different from the expiry date of another lot.

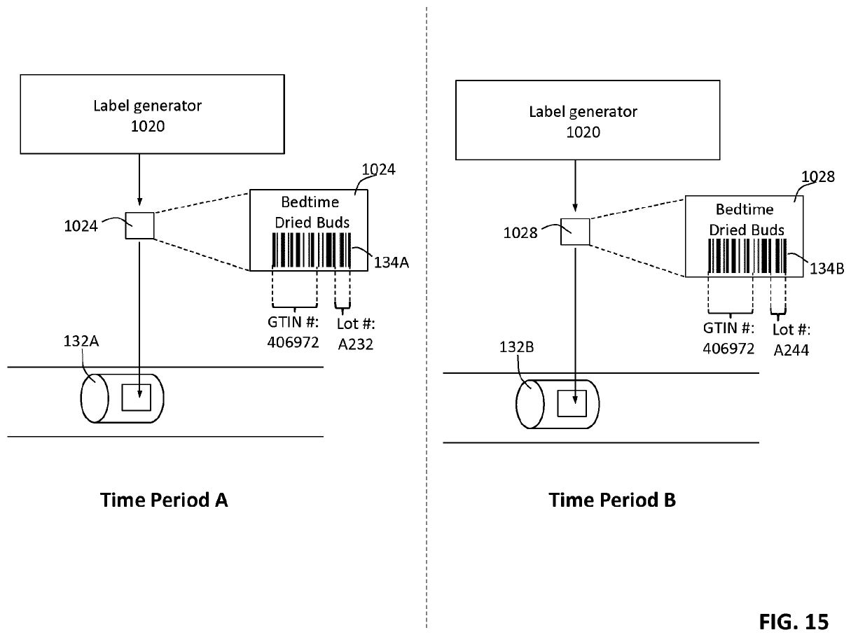

FIG. 15 illustrates operation of a machine 1020 for generating labels, according to one embodiment. The machine 1020 will be referred to as label generator 1020. During time period A, the label generator 1020 generates labels for units of a particular cannabis product originating from a particular batch of cannabis plants. Each label includes a machine-readable code that encodes a number specific to the cannabis product and a number that maps back to an identity of the batch. In the illustrated example, the number specific to the cannabis product is a GTIN and the number that maps back to the identity of the batch is the lot number. For example, in FIG. 15 label 1024 is generated for the cannabis product “Bedtime” dried buds, having a linear barcode 134A that encodes GTIN 406972 and the lot number A232. All labels for “Bedtime” dried buds belonging to the same lot A232 have the same linear barcode 134A, or at least include the same GTIN and lot number. Later, during time period B, when units of the cannabis product from a different batch are being labelled, then the label generator 1020 updates the machine-readable code to at least update the number that maps back to the identity of the batch. For example, in FIG. 14 label 1028 is generated for the cannabis product “Bedtime” dried buds, having a linear barcode 134B that still encodes GTIN 406972, but the lot number is changed to A244. All labels for “Bedtime” dried buds belonging to the same lot A244 have the same linear barcode 134B, or at least include the same GTIN and lot number.

In another embodiment, the label generator 1020 is instead replaced with a machine that generates cannabis product packaging having the machine-readable code. In another embodiment, the label generator 1020 is instead replaced with a machine that generates anything in association with cannabis products that is to have the machine-readable code included thereon.

In view of the above, in some embodiments there is provided a cannabis product including packaging (e.g. a container in which the cannabis product is contained) and a machine-readable code included on or as part of the packaging (e.g. on a label affixed to the packaging). The machine-readable code specifically conveys information that links the cannabis product back to a particular batch of cannabis plants from which cannabis in the cannabis product originates (e.g. the information may be a lot number and/or the batch number).

In some embodiments, a method may include: harvesting a batch of cannabis plants (e.g. batch 150); processing at least some of the cannabis plants to produce a plurality of units of a cannabis product, each unit of the plurality of units belonging to a same lot (e.g. lot A232); and generating a label for each unit, the label including a machine-readable code that conveys a lot number of the lot (e.g. label 1024). Alternatively, instead of a lot number a batch number may be conveyed (e.g. batch number 150).

In some embodiments, a method may include: harvesting a first batch of cannabis plants (e.g. batch 150), and processing at least some of the first batch of cannabis plants to produce a first plurality of units of a cannabis product, each unit of the first plurality of units belonging to a same first lot (e.g. lot A232); harvesting a second batch of cannabis plants (e.g. batch 195), and processing at least some of the second batch of cannabis plants to produce a second plurality of units of the cannabis product, each unit of the second plurality of units belonging to a same second lot (e.g. lot A244); generating a plurality of labels in relation to the cannabis product, each label having a machine-readable code thereon, and wherein: (i) the machine-readable code on every label of the plurality of labels conveys the same number identifying the cannabis product (e.g. GTIN 406972); (ii) for each one of the plurality of labels associated with the first plurality of units, the machine-readable code also conveys a first lot number identifying the first lot (e.g. lot A232); for each one of the plurality of labels associated with the second plurality of units, the machine-readable code also conveys a second lot number identifying the second lot (e.g. lot A244).

### Use of the Machine-Readable Code for Inventory-Related Purposes

In some embodiments, the machine-readable code on a unit of cannabis product conveys the lot number, and the machine-readable code is used by the retailer for tracking inventory in relation to lots.

For example, the retailer may receive a shipment of fifty units of “Bedtime” dried buds belonging to lot 1234 on Oct. 18, 2019. A few months later the retailer may receive a shipment of fifty more units of “Bedtime” dried buds, this time belonging to lot 1295. The retailer may store, in a database, an indication of how many units of each lot has been sold, which may be updated each time a unit is scanned for sale. The retailer may use the database to ensure that sale of units from older lot 1234 are prioritized over sale of units from newer lot 1295.

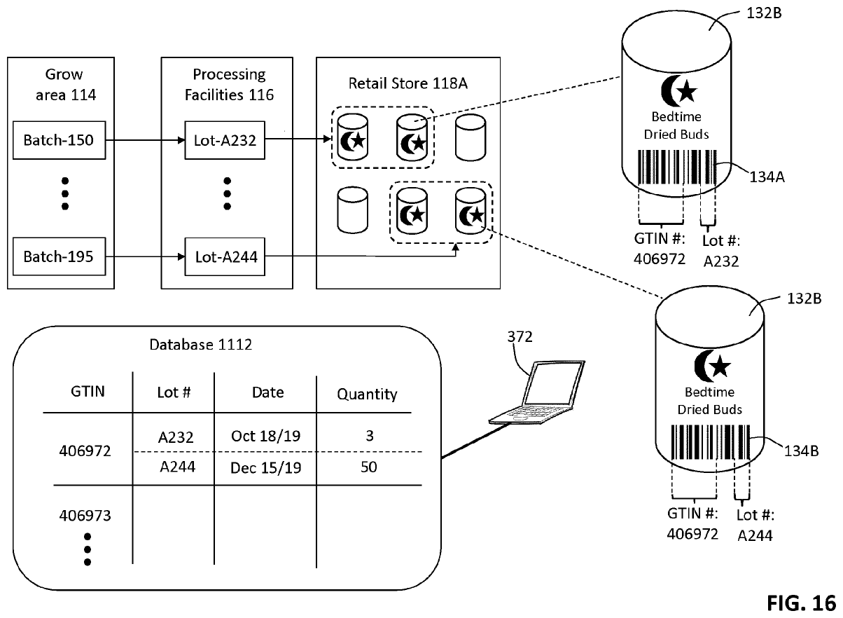

FIG. 16 illustrates an example of inventory tracking, according to one embodiment. A retail store initially receives units of a first lot of a cannabis product, which in the illustrated example are units of “Bedtime” dried buds from lot A232. Each unit has a machine-readable code that conveys an identifier of the cannabis product (unique to “Bedtime” dried buds) and the lot number. In FIG. 16, the machine-readable code is illustrated as barcode 134A having “Bedtime” dried buds GTIN 406972 and lot #A232. A computer 372 of the retailer is used to update inventory database 1112 to indicate the number of units of lot A232 that are now in stock. In one example, the lot number and number of units is entered into the computer manually and transmitted by the computer 372 to the database 1112. In another embodiment, the lot number is obtained by scanning the barcode 134A, and the number of units is received by the computer 372 by either the user manually entering the number of units, or scanning one instance of barcode 134A and manually entering the number of units for that barcode, or scanning the barcode of each unit separately, or scanning a machine-readable code on the shipping container for lot A232 that indicates the number of units in the shipping container.

Over time, units from lot A232 are sold. Upon sale of a unit from the lot, the machine-readable code on that unit is processed (e.g. by the computer 372 or by a barcode scanner at the point of sale in communication with the computer 372) to determine at least the lot number conveyed by the machine-readable code, and possibly also to determine the cannabis product number (e.g. GTIN). The computer 372 uses at least the lot number from the machine-readable code to update the database to indicate one less unit of lot A232.

At some point in the future, another lot A244 of the “Bedtime” dried buds product is received. The shipment of lot A244 may be in response to the quantity of unsold units in lot A232 dropping below a certain threshold. The computer 372 is used to update database 1112 to indicate that units of lot A244 are now also in stock, and to indicate the number of units from lot A244 in stock.

In FIG. 16, the database 1112 links each lot to the product number (e.g. GTIN) so that the number of lots having units in stock in relation to a particular cannabis product can be determined. For example, “Bedtime” dried buds is indicated by GTIN 406972 in the database 1112, and is associated with two lots: A232 having 3 units in stock and A244 having 50 units in stock. A field in the database 1112 may be used to indicate that units of lot A244 are more recent than units of A232, e.g. so that when a customer wants to purchase “Bedtime” dried buds a sale of a unit from A232 can be prioritized over sale of a unit from lot A244. In the illustrated example, a date is stored to indicate which lot is more recent. The date “Oct 18/19” stored in association with lot A232 may correspond to an expiry date, or the date units of lot A232 were added to the database 1112 as stock, or the date of shipment of lot A232, or the date of production of the lot, or another date. The date may be conveyed in the machine-readable code for units of lot A232 (e.g. in barcode 134A). Similarly, the date “Dec 15/19” stored in association with lot A244 may correspond to an expiry date, or the date units of lot A244 were added to the database 1112 as stock, or the date of shipment of lot A244, or the date of production of the lot, or another relevant date. The date may be conveyed in the machine-readable code for units of lot A244 (e.g. in barcode 134B). The fact that the date associated with lot A244 is later than the date associated with lot A232 indicates that units from lot A232 should be prioritized for sale over units from lot 244. For example, in one embodiment, when a sale of “Bedtime” dried buds is to occur, then the computer 372 queries the database and indicates that a unit from lot A232 should be sold. As another example, if the barcode 134B of a unit from lot A244 is scanned at a point of sale, the computer 372 checks the database 1112 and determines that units of lot A232 are still available and are older. The computer 372 then indicates this, e.g. on a GUI of a display, and perhaps stops or inhibits sale of the unit from lot A244.

In some embodiments, the entries stored in the “date” field in the database do not necessarily represent calendar dates, but may represent a date in time relative to each other (e.g. instead of Oct 18/19, the date for lot A232 is “123”, and instead of Dec 15/19, the date for lot A244 is “124”, indicating that lot A232 is older because 123 is less than 124).

In some embodiments, the database 1112 does not include a separate date field. Instead, the lot number indicates which lot is older, e.g. the “232” in lot A232 is a lower number than the “244” in lot “A244”, thereby indicating that units of lot A232 are older and should be prioritized for sale of over units of lot A244.

In view of the above, in one embodiment there is provided a method including: receiving N units of a first lot (e.g. A232) of a cannabis product, each unit of the first lot including a machine-readable code (e.g. 134A) that conveys: (i) optionally a number identifying the cannabis product (e.g. 406972) and (ii) a lot number of the first lot (e.g. A232); updating a database to indicate the N units of the first lot of the cannabis product in stock; upon sale of a unit of the first lot, processing the machine-readable code (e.g. 134A) on the unit to obtain the lot number of the first lot (e.g. A232) and also possibly the number identifying the cannabis product (e.g. 406972), and using at least the lot number of the first lot (e.g. A232) to update the database to indicate one less unit of the first lot in stock; receiving M units of a second lot (e.g. A244) of the cannabis product (where M may or may not equal N), each unit of the second lot including a machine-readable code (e.g. 134B) that conveys (i) optionally the number identifying the cannabis product (e.g. 406972) and (ii) a lot number of the second lot (e.g. A244); updating the database to indicate the M units of the second lot of the cannabis product in stock and to indicate that the second lot of the cannabis product is more recent than the first lot of the cannabis product (e.g. by using the date field or something equivalent, such as the lot number). In the foregoing method, the lot number may be replaced with a batch number instead.

In some embodiments, a method includes processing a machine-readable code of a cannabis product to obtain a lot number conveyed by the machine-readable code, and using the lot number to update information in a database tracking inventory of the lot of the cannabis product. The lot number may be replaced with a batch number instead.

### Cannabis Producer Agnostic Feedback

In many of the embodiments described earlier, it is assumed that the feedback relates only to cannabis products originating from one particular cannabis producer, and the feedback is routed back to that cannabis producer. In other embodiments, a feedback system is provided that is agnostic to the cannabis producer, e.g. it may be implemented via a third party application hosted on a server, where the third party application has no relation to any particular cannabis producer, but is for hosting feedback and/or distributing information in relation to different cannabis products associated with a variety of cannabis producers. The feedback and/or other information may then be made available to consumers and/or potential consumers using the application. In some embodiments, the collected feedback may be sold to cannabis producers.

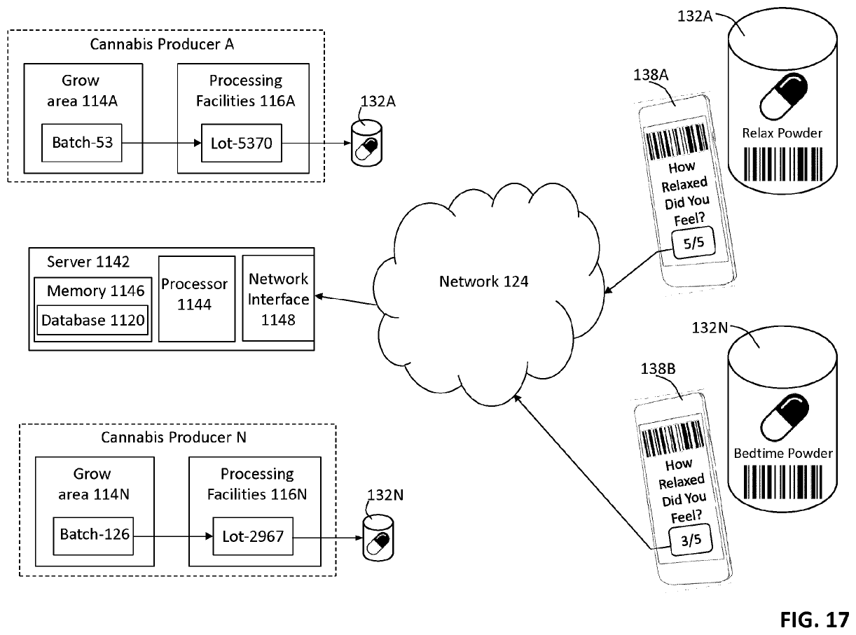

FIG. 17 illustrates a system for electronic feedback that is agnostic of the cannabis producer, according to one embodiment. The feedback methods and variations discussed in detail earlier, e.g. FIG. 5, native application implantation, web application implementation, etc. all still apply. The primary difference is that the server side hosting the application is not associated with a particular cannabis producer, e.g. which may mean that feedback can be collected in relation to different cannabis products from different cannabis producers, and the feedback is stored on a database 1120 that is not associated with any particular cannabis producer.

In FIG. 17, a first cannabis producer, labelled as “cannabis producer A” is associated with a grow area 114A and processing facilities 116A. A different cannabis producer, labelled as “cannabis producer N” is associated with a grow area 114N and processing facilities 116N. FIG. 17 is a simplification. For example, in actual implementation the processing facilities 116A and 116N may be the same facility or facilities owned by a third party that has contracts with cannabis producers A and N to processes cannabis from both suppliers into cannabis products. A cannabis product 132A from lot 5730 and associated with cannabis producer A is sold, and feedback is collected from a first electronic device 138A belonging to a consumer. Another cannabis product 132N from a lot 2967 associated with cannabis producer N is sold, and feedback is collected from another electronic device 138B belonging to another consumer. The feedback from electronic device 138A (in relation to cannabis product 132A) and from electronic device 138B (in relation to cannabis product 132N) are both stored in a database 1120 in memory 1146 of a server 1142. The feedback is transmitted over the network 124 and received at server 1142 via network interface 1148, and the processor 1144 stores the feedback in the database 1120. The application executed by the processor 1114 to collect and store the feedback and communicate with the electronic devices 138A and 138B is independent of cannabis producers A and N. The application executed by the processor 1144 may rank products across different cannabis producers, show consumer feedback, etc. In some embodiments, feedback in relation to a cannabis product does not necessarily need to be collected. A consumer may just wish to use the application to retrieve information in relation to a particular cannabis product using the machine-readable code on that cannabis product.

One example is as follows. The processor 1144 obtains information conveyed by a machine-readable code of a cannabis product via one of the ways described earlier (e.g. the consumer's phone captures a picture of the machine-readable code and the phone either reads the machine-readable code and sends the information from the machine-readable code to the server 1142, or the phone transmits the image of the machine-readable code to the server 1142 and the processor 1144 reads the machine-readable code). The processor 1144 then uses the information conveyed by the machine-readable code to identify and categorize the cannabis product, e.g. by using the product identifier (e.g. GTIN) and/or the lot number conveyed in the machine-readable code. The processor 1144 may then transmit information back to the consumer's electronic device. Examples of such information include one or more of the following: feedback collected from others in relation to the cannabis product and/or lot identified by the machine-readable code; cannabis product image; information relating to authenticity of the cannabis product (e.g. using the method of verification described earlier in relation to FIG. 12); recommendation for other cannabis products, e.g. based on consumer's consumption patterns; a list of products that other consumers purchased; product ranking, etc.

### EXAMPLES

In view of, and in addition to the above, the following examples are disclosed.

Example 1. A method comprising: receiving N units of a first lot of a cannabis product, each unit of the first lot including a machine-readable code that conveys: (i) a number identifying the cannabis product and (ii) a lot number of the first lot; updating a database to indicate the N units of the first lot of the cannabis product in stock; upon sale of a unit of the first lot, processing the machine-readable code on the unit to obtain the number identifying the cannabis product and the lot number of the first lot, and using at least the lot number of the first lot to update the database to indicate one less unit of the first lot in stock; receiving M units of a second lot of the cannabis product (where M may or may not equal N), each unit of the second lot including a machine-readable code that conveys (i) the number identifying the cannabis product and (ii) a lot number of the second lot; updating a database to indicate the M units of the second lot of the cannabis product in stock and to indicate that the second lot of the cannabis product is more recent than the first lot of the cannabis product.

Example 2. The method of Example 1, further comprising a computer, in communication with the database, indicating that a unit of the first lot is to be sold before a unit of the second lot.

Example 3. The method of Example 1 or Example 2, wherein, in relation to a sale of the cannabis product, the computer indicates that a unit of the first lot is to be sold before a unit of the second lot, e.g. the indication may be provided on a display, such as on a GUI.

Example 4. The method of any one of Examples 1 to 3, further comprising prior to sale of a unit of the second lot: processing the machine-readable code on the unit of the second lot to obtain the number identifying the cannabis product and the lot number of the second lot; a computer using at least the lot number of the second lot, which was obtained from the machine-readable code on the unit of the second lot, to query the database to determine whether there is a prior lot of the cannabis product in stock; the computer indicating that a unit of the prior lot should be sold instead of the unit of the second lot when the query indicates the prior lot of the cannabis product is still in stock.

Example 5. The method of Example 4, wherein the prior lot of the cannabis product is the first lot.

Example 6. The method of any one of Examples 1 to 5, wherein the lot number is an alphanumeric number.

Example 7. The method of any one of Examples 1 to 6, wherein the number identifying the cannabis product is a GTIN.

Example 8. The method of any one of Examples 1 to 7, wherein the database stores a first date in association with the first lot and a second date in association with the second lot, and wherein the second date being after the first date is the indication that the second lot of the cannabis product is more recent than the first lot of the cannabis product.

Example 9. The method of Example 8, wherein the first date is a first expiry date conveyed by the machine-readable code on a unit of the first lot, the second date is a second expiry date conveyed by the machine-readable code on a unit of the second lot, and the second expiry date is later than the first expiry date.

Example 10. The method of Example 8, wherein the first date is a date corresponding to when the N units of the first lot were added to the database as stock, wherein the second date is a date corresponding to when the M units of the second lot were added to the database as stock, and the first date is before the second date.

Example 11. The method of Example 8, wherein the first date is a date of shipment of the N units of the first lot, wherein the second date is a date of shipment of the M units of the second lot, and the first date is before the second date.

Example 12. The method of any one of Examples 8 to 11, wherein the first date is conveyed by the machine-readable code on a unit of the first lot, the second date is conveyed by the machine-readable code on a unit of the second lot.

Example 13. The method of Example 12, wherein the first date and the second date each represent a respective calendar date.

Example 14. The method of Example 12, wherein the first date and the second date each do not necessarily represent calendar dates, but represent a date in time relative to each other (e.g. the first date is “123” and the second date is “124” indicating that the second date is later than the first date because “124” exceeds “123”).

Example 15. A method comprising: processing a machine-readable code of a cannabis product to obtain a lot number conveyed by the machine-readable code; using the lot number to update information in a database tracking inventory of the lot of the cannabis product.

Example 16. The method of Example 15, further comprising associating, in the database, different lots with a same brand of cannabis product.

Example 17. The method of Example 15 or Example 16, further comprising a computer indicating which lot is to be sold first for a particular brand of cannabis product.

Example 18. A method comprising: receiving a shipment of units of a first lot of a cannabis product, each unit of the first lot including a machine-readable code that conveys a lot number of the first lot; processing the machine-readable code to obtain the lot number; sending a transmission over a network that includes the lot number; in response to sending the transmission: receiving, over the network, information specific to the first lot.

Example 19. A method comprising: receiving a shipment of units of a first lot of a cannabis product, each unit of the first lot including a machine-readable code that conveys a lot number of the first lot; acquiring a digital image of the machine-readable code; sending a transmission over a network that includes the digital image; in response to sending the transmission: receiving, over the network, information specific to the first lot.

Example 20. The method of Example 18 or Example 19, wherein the information comprises one or more of: information providing a recommendation or suggestion of where the cannabis product should be placed in a retail store and/or how it should be advertised within the retail store; information that identifies authenticity of a unit of the first lot; product information; CoA; testing information; product use and/or product safety and/or product history; recommendations for similar products; recommendations for alternative or substitute products; inventory information.

Example 21. The method of any one of Examples 18 to 20, wherein the machine-readable code is also included on a container in which the units of the first lot are shipped, and it is the machine-readable code on the container that is processed.

Example 22. The method of any one of Examples 1 to 21, wherein a lot number is a number that links the cannabis product back to a particular batch of cannabis plants from which cannabis in the cannabis product originates.

Example 23. A method comprising: harvesting a batch of cannabis plants; processing at least some of the cannabis plants to produce a plurality of units of a cannabis product, each unit of the plurality of units belonging to a same lot; generating a label for each unit, the label including a machine-readable code that conveys a lot number of the lot.

Example 24. The method of Example 23, wherein the machine-readable code further conveys a number identifying the cannabis product.

Example 25. The method of Example 24, wherein the number identifying the cannabis product is the same for different lots of the cannabis product.

Example 26. A method comprising: harvesting a first batch of cannabis plants, and processing at least some of the first batch of cannabis plants to produce a first plurality of units of a cannabis product, each unit of the first plurality of units belonging to a same first lot; harvesting a second batch of cannabis plants, and processing at least some of the second batch of cannabis plants to produce a second plurality of units of the cannabis product, each unit of the second plurality of units belonging to a same second lot; generating a plurality of labels in relation to the cannabis product, each label having a machine-readable code thereon, and wherein: the machine-readable code on every label of the plurality of labels conveys the same number identifying the cannabis product; for each one of the plurality of labels associated with the first plurality of units, the machine-readable code also conveys a first lot number identifying the first lot; for each one of the plurality of labels associated with the second plurality of units, the machine-readable code also conveys a second lot number identifying the second lot.

Example 27. The method of Example 26, wherein the first lot number maps back to the first batch of cannabis plants and the second lot number maps back to the second batch of cannabis plants.

Example 28. A cannabis product comprising: packaging; and a machine-readable code included on or as part of the packaging, wherein the machine-readable code conveys information that links the cannabis product back to a particular batch of cannabis plants from which cannabis in the cannabis product originates.

Example 29. The cannabis product of Example 28, wherein the information is a lot number.

Example 30. The cannabis product of Example 28, wherein the information is a batch number.

Example 31. The cannabis product of any one of Examples 28 to 30, wherein the machine-readable code conveys information identifying a brand of the cannabis product.

Example 32. The cannabis product of Example 31, wherein the information identifying the brand of the cannabis product is the same for all cannabis products of that brand.

Example 33. The method of Example 31 or Example 32, wherein the information identifying the brand of the cannabis product is the same for two different cannabis products that are of the same brand but that originate from different batches of cannabis plants.

Example 34. The cannabis product of any one of Examples 28 to 33, wherein the machine-readable code conveys information identifying a producer of the cannabis product.

Example 35. The cannabis product of any one of Examples 28 to 34, wherein the machine-readable code conveys information identifying an expiry date of the cannabis product.

Example 36. The cannabis product of any one of Examples 28 to 35, wherein the machine-readable code encodes the information.

Example 37. A cannabis product comprising: packaging; and a machine-readable code included on or as part of the packaging, wherein the machine-readable code conveys a lot number associated with the cannabis product.

Example 38. The cannabis product of Example 37, wherein the lot number maps back to a batch of plants from which cannabis in the cannabis product originates.

Example 39. A method of generating a plurality of labels for units of a cannabis product, the method comprising: generating a first plurality of labels for use with a first set of units of the cannabis product, the first set of units of the cannabis product each including cannabis originating from a first batch of cannabis plants, and each one of the first plurality of labels including a respective first machine-readable code that conveys information linking back to the first batch of cannabis plants; generating a second plurality of labels for use with a second set of units of the cannabis product, the second set of units of the cannabis product each including cannabis originating from a second batch of cannabis plants, and each one of the second plurality of labels including a respective second machine-readable code that conveys information linking back to the second batch of cannabis plants.

Example 40. The method of Example 39, wherein the first machine-readable code is the same for each unit of the first set of units, and wherein the second machine-readable code is the same for each unit of the second set of units.

Example 41. The method of Example 40, wherein the first machine-readable code and the second machine-readable code each convey the same identifier of the cannabis product.

Example 42. The method of Example 41, wherein the identifier is a GTIN.

Example 43. The method of any one of Examples 39 to 42, wherein the information linking back to the first batch of cannabis plants is a first lot number, and wherein the information linking back to the second batch of cannabis plants is a second lot number.

Example 44. The method of any one of Examples 39 to 43, further comprising: affixing to each unit of the first set of units a respective one of the first plurality of labels; and affixing to each unit of the second set of units a respective one of the second plurality of labels.

Example 45. An apparatus comprising a label generator configured to perform the method of any one of Examples 39 to 44.

Example 46. A method performed by an electronic device, comprising: implementing a graphical user interface (GUI) on the electronic device that provides an input object that, when selected, activates a camera of the electronic device; acquiring a digital image using the camera, the digital image including a machine-readable code from a cannabis product; processing the digital image of the machine-readable code to obtain information conveyed by the machine-readable code; collecting feedback by the electronic device in relation to the cannabis product; and sending at least one transmission over a network, the at least one transmission including both the feedback and the information conveyed by the machine-readable code to electronically associate the feedback with the information conveyed by the machine-readable code.

Example 47. The method of Example 46, wherein the machine-readable code uniquely identifies a group of cannabis plants from which cannabis in the cannabis product originates, e.g. the machine-readable code conveys a lot number that links back to a specific batch of plants and/or a batch number that links back to the specific batch of plants.

Example 48. The method of Example 46 or Example 47, wherein the information conveyed by the machine-readable code includes a lot number.

Example 49. The method of Example 48, wherein the feedback is electronically linked to the lot number.

Example 50. The method of any one of Examples 46 to 49, wherein the machine-readable code is a barcode, and wherein processing the digital image of the machine-readable code comprises decoding the barcode.

Example 51. The method of Example 50, wherein the barcode is affixed to a container of the cannabis product.

Example 52. The method of any one of Examples 46 to 51, further comprising determining whether the machine-readable code is valid.

Example 53. The method of Example 52, wherein the feedback is transmitted over the network only when the machine-readable code is valid.

Example 54. The method of Example 53, wherein the feedback is collected only when the machine-readable code is valid.

Example 55. The method of any one of Examples 52 to 54, wherein determining whether the machine-readable code is valid comprises comparing information conveyed by the machine-readable code to a valid entry.

Example 56. The method of Example 55, wherein comparing information conveyed by the machine-readable code to a valid entry comprises: comparing a lot number decoded from the machine-readable code to a list of valid lot numbers.

Example 57. The method of Example 55 or Example 56, wherein the comparing occurs at the electronic device.

Example 58. The method of Example 55 or Example 56, wherein the information conveyed by the machine-readable code is transmitted over the network to a server for the comparing to occur, and the result of the comparing is received over the network from the server.

Example 59. The method of any one of Examples 46 to 58, wherein the information conveyed by the machine-readable code uniquely identifies a cannabis producer and/or cannabis product producer.

Example 60. The method of any one of Examples 46 to 59, wherein collecting the feedback by the electronic device in relation to the cannabis product occurs in response to acquiring the machine-readable code.

Example 61. The method of Example 60, wherein collecting the feedback occurs in response to successfully obtaining the information conveyed by the machine-readable code.

Example 62. The method of Example 60 or Example 61, wherein the machine-readable code is a barcode, and wherein collecting the feedback occurs in response to successfully decoding the barcode.

Example 63. The method of any one of Examples 46 to 62, wherein at least some of the feedback is specific to the cannabis product.

Example 64. The method of any one of Examples 46 to 63, wherein at least some of the feedback is specific to a group of cannabis plants from which cannabis in the cannabis product originates.

Example 65. The method of any one of Examples 46 to 64, wherein at least some of the feedback is specific to a lot.

Example 66. The method of Example 65, wherein the feedback is electronically linked to a lot number of the lot.

Example 67. The method of any one of Examples 46 to 66, wherein at least some of the feedback is not specific to the cannabis product even though it is collected in relation to the cannabis product.

Example 68. The method of Example 67, wherein the feedback not specific to the cannabis product comprises one or more of the following: IP address of the electronic device; GPS coordinates of the electronic device; age or age range of the consumer; list of other cannabis products purchased and/or consumed; frequency of purchases of cannabis products; general purchasing habits of consumer; frequented locations of electronic device; information from social media applications; customer account number; time and/or date information; a sensor reading from the electronic device; information previously entered by a user and stored in memory of the electronic device.

Example 69. The method of any one of Examples 46 to 68, wherein the method does not include using the GUI to request that a user input feedback.

Example 70. The method of any one of Examples 46 to 68, wherein collecting the feedback comprises using the GUI to request that a user input feedback, and receiving one or more inputs from the user in response to the request.

Example 71. The method of any one of Examples 46 to 70, further comprising displaying a message on the GUI requesting permission to collect the feedback prior to collecting the feedback, and collecting the feedback in response to a user input granting permission to collect the feedback.

Example 72. The method of any one of Examples 46 to 71, wherein the electronic device is associated with a consumer.

Example 73. The method of any one of Examples 46 to 71, wherein the electronic device is associated with a retailer.

Example 74. The method of Example 73, wherein the feedback comprises one or more of the following: number of units sold from a lot the cannabis product is associated with; date and/or time of sale of the cannabis product; feedback entered by a person associated with the retail store; information obtained from a customer during sale of the cannabis product; identity of a person that sold the cannabis product.

Example 75. The method of any one of Examples 46 to 74, further comprising receiving, at the electronic device, information specific to the cannabis product.

Example 76. The method of Example 75, wherein the information specific to the cannabis product is retrieved using the information conveyed by the machine-readable code.

Example 77. The method of Example 76, wherein the information specific to the cannabis product is electronically linked in a database to the information conveyed by the machine-readable code.

Example 78. The method of any one of Examples 75 to 77, wherein the information specific to the cannabis product is received from a server in response to transmitting the feedback over the network.

Example 79. The method of any one of Examples 75 to 78, wherein transmitting the information conveyed by the machine-readable code acts as a request for the information specific to the cannabis product.

Example 80. The method of any one of Examples 46 to 79, wherein at least some of the feedback is used to track the cannabis product.

Example 81. An electronic device, comprising: a display; a camera; and a processor; the processor configured to implement a graphical user interface (GUI) on the display that provides an input object that, when selected, activates a camera of the electronic device; the camera configured to acquire a digital image, the digital image including a machine-readable code from a cannabis product; the processor further configured to: process the digital image of the machine-readable code to obtain information conveyed by the machine-readable code; collect feedback by the electronic device in relation to the cannabis product; and cause at least one transmission to be sent over a network, the at least one transmission including both the feedback and the information conveyed by the machine-readable code to electronically associate the feedback with the information conveyed by the machine-readable code.

Example 82. An electronic device configured to perform the method of any one of Examples 46 to 80.

Example 83. An electronic device comprising a display, a camera, and a processor; wherein the processor is configured to execute instructions to cause the electronic device to perform the method of any one of Examples 46 to 80.

Example 84. A computer program product comprising a computer readable memory storing computer executable instructions thereon that, when executed by an electronic device, cause the electronic device to perform the method of any one of Examples to 46 to 80.

Example 85. A method comprising: receiving, from a first electronic device over a network, both: (i) first feedback that was collected by the first electronic device in relation to a first cannabis product, and (ii) first information that was obtained by the first electronic device from processing a digital image of a machine-readable code from the first cannabis product; receiving, from a second electronic device over the network, both: (i) second feedback that was collected by the second electronic device in relation to a second cannabis product, and (ii) second information that was obtained by the second electronic device from processing a digital image of a machine-readable code from the second cannabis product; storing the first feedback in memory in association with the first information, and storing the second feedback in memory in association with the second information.

Example 86. The method of Example 85, wherein each machine-readable code uniquely identifies a group of cannabis plants from which cannabis in a cannabis product corresponding to that machine-readable code originates, e.g. the machine-readable code conveys a lot number that links back to a specific batch of plants and/or a batch number that links back to the specific batch of plants.

Example 87. The method of Example 85 or Example 86, wherein the first feedback is electronically linked to a lot number of a lot associated with the first cannabis product, and wherein the second feedback is electronically linked to another lot number of another lot that is associated with the second cannabis product.

Example 88. The method of any one of Examples 85 to 87, further comprising receiving and determining whether the first information is valid before receiving the first feedback.

Example 89. The method of Example 88, wherein the first feedback is received in response to the first information first being found to be valid.

Example 90. The method of Example 88 or Example 89, wherein determining whether the first information is valid comprises comparing the first information to a valid entry in memory to confirm a match.

Example 91. The method of Example 90, wherein the comparing the first information to a valid entry comprises: comparing a lot number associated with the first cannabis product and received from the first electronic device to a list of valid lot numbers.

Example 92. The method of any one of Examples 88 to 91, wherein: in response to determining that the first information is valid, transmitting a message to the first electronic device, the message providing permission for the first feedback to be sent.

Example 93. The method of any one of Examples 85 to 92, wherein at least some of the first feedback is specific to the first cannabis product.

Example 94. The method of any one of Examples 85 to 93, wherein at least some of the first feedback is specific to a group of cannabis plants from which cannabis in the first cannabis product originates.

Example 95. The method of any one of Examples 85 to 94, wherein at least some of the first feedback is specific to a lot.

Example 96. The method of any one of Examples 85 to 95, wherein at least some of the first feedback is not specific to the first cannabis product even though it is collected in relation to the first cannabis product.

Example 97. The method of any one of Examples 85 to 96, further comprising transmitting, to the first electronic device, information specific to the first cannabis product.

Example 98. The method of Example 97, wherein the information specific to the first cannabis product is retrieved using the first information.

Example 99. The method of Example 98, wherein the information specific to the first cannabis product is electronically linked in memory to the first information.

Example 100. The method of any one of Examples 97 to 99, wherein the information specific to the first cannabis product is transmitted to the first electronic device in response to receiving the first feedback.

Example 101. The method of any one of Examples 97 to 100, wherein receipt of the first information acts as a request for the information specific to the first cannabis product.

Example 102. The method of any one of Examples 85 to 101, wherein at least some of the first feedback is used to track the first cannabis product.

Example 103. The method of any one of Examples 85 to 102, wherein the first feedback and the second feedback share a common format.

Example 104. The method of any one of Examples 85 to 103, wherein the first cannabis product and the second cannabis products are different types of cannabis products.

Example 105. The method of any one of Examples 85 to 104, wherein the first information uniquely identifies at least one of the following: cannabis producer; cannabis product producer; type of cannabis product; brand of cannabis product.

Example 106. The method of any one of Examples 85 to 105, wherein a cultivation and/or harvesting and/or processing technique is modified based on the first feedback.

Example 107. A server comprising: a network interface; a memory; and a processor; the processor configured to cause the server to: receive, from a first electronic device over a network via the network interface, both: (i) first feedback that was collected by the first electronic device in relation to a first cannabis product, and (ii) first information that was obtained by the first electronic device from processing a digital image of a machine-readable code from the first cannabis product; receive, from a second electronic device over the network via the network interface, both: (i) second feedback that was collected by the second electronic device in relation to a second cannabis product, and (ii) second information that was obtained by the second electronic device from processing a digital image of a machine-readable code from the second cannabis product; store the first feedback in the memory in association with the first information, and store the second feedback in the memory in association with the second information.

Example 108. A server configured to perform the method of any one of Examples 85 to 106.

Example 109. A server comprising a network interface, a memory, and a processor; wherein the processor is configured to execute instructions to cause the server to perform the method of any one of Examples 85 to 106.

Example 110. A computer program product comprising a computer readable memory storing computer executable instructions thereon that, when executed by a processor, cause a server to perform the method of any one of Examples to 85 to 106.

Example 111. A method performed by an electronic device, comprising: implementing a graphical user interface (GUI) on the electronic device that provides an input object that, when selected, activates a camera of the electronic device; acquiring a digital image using the camera, the digital image including a machine-readable code from a cannabis product; collecting feedback by the electronic device in relation to the cannabis product; and sending at least one transmission over a network, the at least one transmission including both the feedback and the digital image to electronically associate the feedback with the digital image.

Example 112. The method of Example 111, wherein the machine-readable code uniquely identifies a group of cannabis plants from which cannabis in the cannabis product originates, e.g. the machine-readable code conveys a lot number that links back to a specific batch of plants and/or a batch number that links back to the specific batch of plants.

Example 113. The method of Example 111 or Example 112, wherein information conveyed by the machine-readable code includes a lot number corresponding to a group of cannabis plants from which cannabis in the cannabis product originates.

Example 114. The method of any one of Examples 111 to 113, wherein the machine-readable code is a barcode.

Example 115. The method of Example 114, wherein the barcode is affixed to a container of the cannabis product.

Example 116. The method of any one of Examples 111 to 115, comprising: transmitting the digital image over the network prior to transmitting the feedback, receiving an indication that the machine-readable code is valid, and in response transmitting the feedback.

Example 117. The method of Example 116, wherein collecting the feedback occurs in response to receiving the indication that the machine-readable code is valid.

Example 118. The method of Example 116 or Example 117, wherein the machine-readable code is valid when information conveyed by the machine-readable code matches valid information.

Example 119. The method of any one of Examples 111 to 118, wherein collecting the feedback by the electronic device in relation to the cannabis product occurs in response to acquiring the digital image.

Example 120. The method of any one of Examples 111 to 119, wherein collecting the feedback occurs in response to a message received over a network, the message indicating that information conveyed by the machine-readable code was successfully decoded.

Example 121. The method of any one of Examples 111 to 120, comprising: transmitting the digital image over the network prior to transmitting the feedback, receiving a message over the network indicating that the electronic device is to transmit the feedback, and in response transmitting the feedback.

Example 122. The method of Example 121, wherein the message indicates that: the machine-readable code is valid and/or that the electronic device has permission to transmit the feedback and/or that information from the machine-readable code was successfully decoded.

Example 123. The method of any one of Examples 111 to 122, wherein at least some of the feedback is specific to the cannabis product.

Example 124. The method of any one of Examples 111 to 123, wherein at least some of the feedback is specific to a group of cannabis plants from which cannabis in the cannabis product originates.

Example 125. The method of any one of Examples 111 to 124, wherein at least some of the feedback is specific to a lot.

Example 126. The method of any one of Examples 111 to 125, wherein at least some of the feedback is not specific to the cannabis product even though it is collected in relation to the cannabis product.

Example 127. The method of Example 126, wherein the feedback not specific to the cannabis product comprises one or more of the following: IP address of the electronic device; GPS coordinates of the electronic device; age or age range of the consumer; list of other cannabis products purchased and/or consumed; frequency of purchases of cannabis products; general purchasing habits of consumer; frequented locations of electronic device; information from social media applications; customer account number; time and/or date information; a sensor reading from the electronic device; information previously entered by a user and stored in memory of the electronic device.

Example 128. The method of any one of Examples 111 to 127, wherein the method does not include using the GUI to request that a user input feedback.

Example 129. The method of any one of Examples 111 to 127, wherein collecting the feedback comprises using the GUI to request that a user input feedback, and receiving one or more inputs from the user in response to the request.

Example 130. The method of any one of Examples 111 to 129, further comprising displaying a message on the GUI requesting permission to collect the feedback prior to collecting the feedback, and collecting the feedback in response to a user input granting permission to collect the feedback.

Example 131. The method of any one of Examples 111 to 130, wherein the electronic device is associated with a consumer.

Example 132. The method of any one of Examples 111 to 130, wherein the electronic device is associated with a retailer.

Example 133. The method of Example 132, wherein the feedback comprises one or more of the following: number of units sold from a lot the cannabis product is associated with; date and/or time of sale of the cannabis product; feedback entered by a person associated with the retail store; information obtained from a customer during sale of the cannabis product; identity of a person that sold the cannabis product.

Example 134. The method of any one of Examples 111 to 133, further comprising receiving, at the electronic device, information specific to the cannabis product.

Example 135. The method of Example 134, wherein the information specific to the cannabis product is received from a server in response to transmitting the digital image over the network.

Example 136. The method of Example 134 or Example 135, wherein transmitting the digital image acts as a request for the information specific to the cannabis product.

Example 137. An electronic device, comprising: a display; a camera; and a processor; the processor configured to implement a graphical user interface (GUI) on the display that provides an input object that, when selected, activates a camera of the electronic device; the camera configured to acquire a digital image, the digital image including a machine-readable code from a cannabis product; the processor further configured to: collect feedback by the electronic device in relation to the cannabis product; and send at least one transmission over a network, the at least one transmission including both the feedback and the digital image to electronically associate the feedback with the digital image.

Example 138. An electronic device configured to perform the method of any one of Examples 111 to 136.

Example 139. An electronic device comprising a display, a camera, and a processor; wherein the processor is configured to execute instructions to cause the electronic device to perform the method of any one of Examples 111 to 136.

Example 140. A computer program product comprising a computer readable memory storing computer executable instructions thereon that, when executed by an electronic device, cause the electronic device to perform the method of any one of Examples to 111 to 136.

Example 141. A method comprising: receiving, from an electronic device over a network, both: (i) feedback that was collected by the electronic device in relation to a cannabis product, and (ii) a digital image including a machine-readable code from the cannabis product; processing the digital image of the machine-readable code to obtain information conveyed by the machine-readable code; storing the feedback in memory in association with the information conveyed by the machine-readable code.

Example 142. The method of Example 141, wherein the machine-readable code uniquely identifies a group of cannabis plants from which cannabis in the cannabis product originates, e.g. the machine-readable code conveys a lot number that links back to a specific batch of plants and/or a batch number that links back to the specific batch of plants.

Example 143. The method of Example 141 or Example 142, wherein the information conveyed by the machine-readable code includes a lot number corresponding to a group of cannabis plants from which cannabis in the cannabis product originates.

Example 144. The method of Example 143, wherein the feedback is electronically linked to the lot number.

Example 145. The method of any one of Examples 141 to 144, wherein the machine-readable code is a barcode, and wherein processing the digital image of the machine-readable code comprises decoding the barcode.

Example 146. The method of Example 145, wherein the barcode is affixed to a container of the cannabis product.

Example 147. The method of any one of Examples 141 to 146, further comprising determining whether the machine-readable code is valid.

Example 148. The method of Example 147, comprising transmitting a message to the electronic device requesting that the feedback be sent from the electronic device in response to determining that the machine-readable code is valid.

Example 149. The method of Example 147 or Example 148, wherein determining whether the machine-readable code is valid comprises comparing information conveyed by the machine-readable code to a valid entry in memory.

Example 150. The method of Example 149, wherein comparing information conveyed by the machine-readable code to a valid entry comprises: comparing a lot number decoded from the machine-readable code to a list of valid lot numbers.

Example 151. The method of Example 149 or Example 150, wherein the result of the comparing is transmitted to the electronic device.

Example 152. The method of any one of Examples 141 to 151, wherein the information conveyed by the machine-readable code uniquely identifies a cannabis producer and/or cannabis product producer.

Example 153. The method of any one of Examples 141 to 152, comprising transmitting a message to the electronic device requesting that the feedback be sent from the electronic device in response to successfully processing the machine-readable code.

Example 154. The method of Example 153, wherein the machine-readable code is a barcode, and wherein successfully processing the machine-readable code comprises successfully decoding the barcode.

Example 155. The method of any one of Examples 141 to 154, wherein at least some of the feedback is specific to the cannabis product.

Example 156. The method of any one of Examples 141 to 155, wherein at least some of the feedback is specific to a group of cannabis plants from which cannabis in the cannabis product originates.

Example 157. The method of any one of Examples 141 to 156, wherein at least some of the feedback is specific to a lot.

Example 158. The method of Example 157, wherein the feedback is electronically linked to a lot number of the lot.

Example 159. The method of any one of Examples 141 to 158, wherein at least some of the feedback is not specific to the cannabis product even though it is collected in relation to the cannabis product.

Example 160. The method of Example 159, wherein the feedback not specific to the cannabis product comprises one or more of the following: IP address of the electronic device; GPS coordinates of the electronic device; age or age range of the consumer; list of other cannabis products purchased and/or consumed; frequency of purchases of cannabis products; general purchasing habits of consumer; frequented locations of electronic device; information from social media applications; customer account number; time and/or date information; a sensor reading from the electronic device; information previously entered by a user and stored in memory of the electronic device.

Example 161. The method of any one of Examples 141 to 160, wherein the electronic device is associated with a consumer.

Example 162. The method of any one of Examples 141 to 160, wherein the electronic device is associated with a retailer.

Example 163. The method of Example 162, wherein the feedback comprises one or more of the following: number of units sold from a lot the cannabis product is associated with; date and/or time of sale of the cannabis product; feedback entered by a person associated with the retail store; information obtained from a customer during sale of the cannabis product; identity of a person that sold the cannabis product.

Example 164. The method of any one of Examples 141 to 163, further comprising using the information conveyed by the machine-readable code to retrieve information specific to the cannabis product, and sending the information specific to the cannabis product to the electronic device.

Example 165. The method of Example 164, wherein the information specific to the cannabis product is electronically linked in a database to the information conveyed by the machine-readable code.

Example 166. The method of Example 164 or Example 165, wherein the information specific to the cannabis product is retrieved and sent to the electronic device in response to receiving the feedback from the electronic device.

Example 167. The method of any one of Examples 164 to 166, wherein the digital image acts as a request for the information specific to the cannabis product.

Example 168. The method of any one of Examples 141 to 167, wherein at least some of the feedback is used to track the cannabis product.

Example 169. A server comprising: a network interface; a memory; and a processor; the processor configured to cause the server to: receive, from an electronic device over a network via the network interface, both: (i) feedback that was collected by the electronic device in relation to a cannabis product, and (ii) a digital image including a machine-readable code from the cannabis product; process the digital image of the machine-readable code to obtain information conveyed by the machine-readable code; store the feedback in the memory in association with the information conveyed by the machine-readable code.

Example 170. A server configured to perform the method of any one of Examples 141 to 168.

Example 171. A server comprising a network interface, a memory, and a processor; wherein the processor is configured to execute instructions to cause the server to perform the method of any one of Examples 141 to 168.

Example 172. A computer program product comprising a computer readable memory storing computer executable instructions thereon that, when executed by a processor, cause a server to perform the method of any one of Examples to 141 to 168.

Example 173. A method performed by an electronic device, comprising: receiving a message over a network from a server, the message requesting permission to activate a camera of the electronic device; activating the camera and acquiring a digital image using the camera, the digital image including a machine-readable code from a cannabis product; transmitting the digital image over the network to the server; receiving at least one message over the network, the at least one message soliciting feedback; in response to receipt of the at least one message, collecting the feedback in relation to the cannabis product; transmitting the feedback over the network to the server for storage in association with information conveyed by the machine-readable code.

Example 174. The method of Example 173, wherein the machine-readable code uniquely identifies a group of cannabis plants from which cannabis in the cannabis product originates, e.g. the machine-readable code conveys a lot number that links back to a specific batch of plants and/or a batch number that links back to the specific batch of plants.

Example 175. The method of Example 173 or Example 174, wherein information conveyed by the machine-readable code includes a lot number corresponding to a group of cannabis plants from which cannabis in the cannabis product originates.

Example 176. The method of any one of Examples 173 to 175, wherein the machine-readable code is a barcode.

Example 177. The method of Example 176, wherein the barcode is affixed to a container of the cannabis product.

Example 178. The method of any one of Examples 173 to 177, comprising: transmitting the digital image prior to transmitting the feedback, receiving an indication that the machine-readable code is valid, and in response transmitting the feedback.

Example 179. The method of Example 178, wherein collecting the feedback occurs in response to receiving the indication that the machine-readable code is valid.

Example 180. The method of Example 178 or Example 179, wherein the machine-readable code is valid when information conveyed by the machine-readable code matches valid information.

Example 181. The method of any one of Examples 173 to 180, wherein the at least one message soliciting feedback comprises an indication that: the machine-readable code is valid and/or that the electronic device has permission to transmit the feedback and/or that information from the machine-readable code was successfully decoded.

Example 182. The method of any one of Examples 173 to 181, wherein at least some of the feedback is specific to the cannabis product.

Example 183. The method of any one of Examples 173 to 182, wherein at least some of the feedback is specific to a group of cannabis plants from which cannabis in the cannabis product originates.

Example 184. The method of any one of Examples 173 to 183, wherein at least some of the feedback is specific to a lot.

Example 185. The method of any one of Examples 173 to 184, wherein at least some of the feedback is not specific to the cannabis product even though it is collected in relation to the cannabis product.

Example 186. The method of Example 185, wherein the feedback not specific to the cannabis product comprises one or more of the following: IP address of the electronic device; GPS coordinates of the electronic device; age or age range of the consumer; list of other cannabis products purchased and/or consumed; frequency of purchases of cannabis products; general purchasing habits of consumer; frequented locations of electronic device; information from social media applications; customer account number; time and/or date information; a sensor reading from the electronic device; information previously entered by a user and stored in memory of the electronic device.

Example 187. The method of any one of Examples 173 to 186, wherein the method does not include using a GUI of the electronic device to request that a user input feedback.

Example 188. The method of any one of Examples 173 to 186, wherein collecting the feedback comprises using a GUI of the electronic device to request that a user input feedback, and receiving one or more inputs from the user in response to the request.

Example 189. The method of Example 188, wherein the GUI is displayed by a browser of the electronic device, and the feedback is transmitted by a browser application to the server.

Example 190. The method of any one of Examples 173 to 189, further comprising displaying a message on the GUI requesting permission to collect the feedback prior to collecting the feedback, and collecting the feedback in response to a user input granting permission to collect the feedback.

Example 191. The method of any one of Examples 173 to 190, wherein the electronic device is associated with a consumer.

Example 192. The method of any one of Examples 173 to 191, wherein the electronic device is associated with a retailer.

Example 193. The method of Example 192, wherein the feedback comprises one or more of the following: number of units sold from a lot the cannabis product is associated with; date and/or time of sale of the cannabis product; feedback entered by a person associated with the retail store; information obtained from a customer during sale of the cannabis product; identity of a person that sold the cannabis product.

Example 194. The method of any one of Examples 173 to 193, further comprising receiving, at the electronic device, information specific to the cannabis product.

Example 195. The method of Example 194, wherein the information specific to the cannabis product is received from a server in response to transmitting the digital image over the network.

Example 196. The method of Example 194 or Example 195, wherein transmitting the digital image acts as a request for the information specific to the cannabis product.

Example 197. The method of any one of Examples 173 to 196, wherein the method is executed using a browser application on the electronic device.

Example 198. The method of Example 197, wherein the browser application causes transmission of the digital image to the server and causes transmission of the feedback to the server.

Example 199. The method of Example 197 or Example 198, comprising the browser on the electronic device contacting and communicating with the server, and wherein the message requesting permission to activate the camera is displayed in the browser.

Example 200. The method of any one of Examples 197 to 199 comprising the browser navigating to a website to initiate the method.

Example 201. An electronic device, comprising: a display; a camera; and a processor; the processor configured to execute a browser application that causes the electronic device to: receive a message over a network from a server, the message requesting permission to activate a camera of the electronic device; activate the camera and acquiring a digital image using the camera, the digital image including a machine-readable code from a cannabis product; transmit the digital image over the network to the server; receive at least one message over the network, the at least one message soliciting feedback; in response to receipt of the at least one message, collect the feedback in relation to the cannabis product; transmit the feedback over the network to the server for storage in association with information conveyed by the machine-readable code.

Example 202. An electronic device configured to perform the method of any one of Examples 173 to 200.

Example 203. An electronic device comprising a display, a camera, and a processor; wherein the processor is configured to execute instructions to cause the electronic device to perform the method of any one of Examples 173 to 200.

Example 204. A computer program product comprising a computer readable memory storing computer executable instructions thereon that, when executed by an electronic device, cause the electronic device to perform the method of any one of Examples to 173 to 200.

Example 205. A method comprising: transmitting a message over a network to an electronic device, the message requesting permission to activate a camera of the electronic device; receiving a digital image over the network from the electronic device, the digital image including a machine-readable code from a cannabis product; processing the digital image of the machine-readable code to obtain information conveyed by the machine-readable code; transmitting at least one message over the network to the electronic device, the at least one message soliciting feedback; receiving the feedback over the network from the electronic device; storing the feedback in memory in association with the information conveyed by the machine-readable code.

Example 206. The method of Example 205, wherein the machine-readable code uniquely identifies a group of cannabis plants from which cannabis in the cannabis product originates, e.g. the machine-readable code conveys a lot number that links back to a specific batch of plants and/or a batch number that links back to the specific batch of plants.

Example 207. The method of Example 205 or Example 206, wherein the information conveyed by the machine-readable code includes a lot number corresponding to a group of cannabis plants from which cannabis in the cannabis product originates.

Example 208. The method of Example 207, wherein the feedback is electronically linked to the lot number.

Example 209. The method of any one of Examples 205 to 208, wherein the machine-readable code is a barcode, and wherein processing the digital image of the machine-readable code comprises decoding the barcode.

Example 210. The method of any one of Examples 205 to 209, further comprising determining whether the machine-readable code is valid.

Example 211. The method of Example 210, comprising transmitting the at least one message soliciting feedback in response to determining that the machine-readable code is valid.

Example 212. The method of Example 210 or Example 211, wherein determining whether the machine-readable code is valid comprises comparing information conveyed by the machine-readable code to a valid entry in memory.

Example 213. The method of Example 212, wherein comparing information conveyed by the machine-readable code to a valid entry comprises: comparing a lot number decoded from the machine-readable code to a list of valid lot numbers.

Example 214. The method of Example 212 or Example 213, wherein the result of the comparing is transmitted to the electronic device.

Example 215. The method of any one of Examples 205 to 214, comprising transmitting the at least one message soliciting feedback in response to successfully processing the machine-readable code.

Example 216. The method of Example 215, wherein the machine-readable code is a barcode, and wherein successfully processing the machine-readable code comprises successfully decoding the barcode.

Example 217. The method of any one of Examples 205 to 216, wherein at least some of the feedback is specific to the cannabis product.

Example 218. The method of any one of Examples 205 to 217, wherein at least some of the feedback is specific to a group of cannabis plants from which cannabis in the cannabis product originates.

Example 219. The method of any one of Examples 205 to 218, wherein at least some of the feedback is specific to a lot.

Example 220. The method of Example 219, wherein the feedback is electronically linked to a lot number of the lot.

Example 221. The method of any one of Examples 205 to 220, wherein at least some of the feedback is not specific to the cannabis product even though it is collected in relation to the cannabis product.

Example 222. The method of any one of Examples 205 to 221, further comprising using the information conveyed by the machine-readable code to retrieve information specific to the cannabis product, and sending the information specific to the cannabis product to the electronic device.

Example 223. The method of Example 222, wherein the information specific to the cannabis product is electronically linked in a database to the information conveyed by the machine-readable code.

Example 224. The method of Example 222 or Example 223, wherein the information specific to the cannabis product is retrieved and sent to the electronic device in response to receiving the feedback from the electronic device.

Example 225. The method of any one of Examples 222 to 224, wherein the digital image acts as a request for the information specific to the cannabis product.

Example 226. The method of any one of Examples 205 to 225, wherein the method is performed by a web application hosted on the server.

Example 227. The method of Example 226, wherein the server communicates with a browser application on the electronic device.

Example 228. The method of Example 227, wherein the message requesting permission to activate the camera and the message soliciting feedback are sent to a browser of the electronic device, and the digital image and the feedback are received from the browser of the electronic device.

Example 229. A server comprising: a network interface; a memory; and a processor; the processor configured to cause the server to: transmit a message over a network to an electronic device, the message requesting permission to activate a camera of the electronic device; receive a digital image over the network from the electronic device, the digital image including a machine-readable code from a cannabis product; process the digital image of the machine-readable code to obtain information conveyed by the machine-readable code; transmit at least one message over the network to the electronic device, the at least one message soliciting feedback; receive the feedback over the network from the electronic device; store the feedback in memory in association with the information conveyed by the machine-readable code.

Example 230. A server configured to perform the method of any one of Examples 205 to 228.

Example 231. A server comprising a network interface, a memory, and a processor; wherein the processor is configured to execute instructions to cause the server to perform the method of any one of Examples 205 to 228.

Example 232. A computer program product comprising a computer readable memory storing computer executable instructions thereon that, when executed by a processor, cause a server to perform the method of any one of Examples to 205 to 228.

Example 233. A method performed by the electronic device comprising: implementing a graphical user interface (GUI) on the electronic device that provides an input object that, when selected, activates a camera of the electronic device; acquiring a digital image using the camera, the digital image including a machine-readable code from a cannabis product; processing the digital image of the machine-readable code to obtain information conveyed by the machine-readable code, the information including a uniform resource locator (URL); collecting feedback by the electronic device in relation to the cannabis product; and sending at least one transmission over a network to an internet protocol (IP) address obtained from the URL, the at least one transmission including the feedback.

Example 234. The method of Example 233, wherein the feedback is electronically associated with the machine-readable code by transmission of the feedback to the IP address obtained from the URL conveyed by the machine-readable code.

Example 235. The method of Example 233 or Example 234, wherein the information conveyed by the machine-readable code further includes a unique identifier of a group of cannabis plants from which cannabis in the cannabis product originates, e.g. the machine-readable code conveys a lot number that links back to a specific batch of plants and/or a batch number that links back to the specific batch of plants.

Example 236. The method of Example 235, wherein the unique identifier is a lot number.

Example 237. The method of Example 235 or Example 236, wherein the unique identifier is transmitted to the IP address and electronically links the feedback to the group of cannabis plants.

Example 238. The method of any one of Examples 235 to 237, further comprising receiving information specific to the cannabis product in response to transmitting a request to the IP address.

Example 239. The method of Example 238, wherein the request is sent prior to sending the feedback.

Example 240. The method of Example 238, wherein the feedback acts as the request.

Example 241. A method performed by the electronic device comprising: receiving a message over a network, the message requesting permission to activate a camera of the electronic device; activating the camera and acquiring a digital image using the camera, the digital image including a machine-readable code from a cannabis product; transmitting the digital image over the network; receiving a message over the network, the message including a uniform resource locator (URL) that was obtained from the digital image; collecting feedback by the electronic device in relation to the cannabis product; and sending at least one transmission over a network to an IP address obtained from the URL, the at least one transmission including the feedback.

Example 242. A method comprising: hosting a plurality of webpages on at least one server, each webpage having a uniform resource locator (URL) corresponding to: a respective lot and/or a respective group (e.g. batch) of cannabis plants; receiving, over a network, first feedback that was collected by a first electronic device in relation to a first cannabis product, the first feedback sent to a first URL; receiving, over the network, second feedback that was collected by a second electronic device in relation to a second cannabis product, the second feedback sent to a second URL; storing the first feedback in association with an identifier of a first lot (and/or an identifier of a first group of cannabis plants) corresponding to the first URL, and storing the second feedback in association with an identifier of a second lot (and/or an identifier of a second group of cannabis plants) corresponding to the second URL.

Example 243. A method comprising: varying a cultivation and/or harvesting and/or processing technique in relation to a particular lot and/or batch of plants; receiving, over a computer network, feedback in relation to a cannabis product associated with the particular lot and/or batch of plants; and modifying a cultivation and/or harvesting and/or processing technique in response to the feedback.

Example 244. A method comprising receiving, over a computer network, feedback in relation to cannabis products, and generating a consumer profile using the feedback.

Example 245. The method of Example 244, wherein the consumer profile includes one or more of: age range; location at which the cannabis products were purchased and/or consumed; feedback from retail stores; sales comparison between different types of the cannabis products.

Example 246. A method comprising: receiving, over a computer network, a number conveyed by a machine readable code of a cannabis product, wherein the number is a lot number and/or a batch number; checking the validity of the number; and transmitting a message back over the computer network indicating that the cannabis product is valid.

Example 247. The method of Example 246, wherein checking the validity of the number comprises comparing the number to a list of valid numbers and/or determining that there is still inventory to be sold that corresponds to the number.

Example 248. A method performed by an electronic device, comprising: implementing a graphical user interface (GUI) on the electronic device that provides an input object that, when selected, activates a camera of the electronic device; acquiring a digital image using the camera, the digital image including a machine-readable code from a cannabis product; processing the digital image of the machine-readable code to obtain information conveyed by the machine-readable code; sending a transmission over a network that includes the information conveyed by the machine-readable code; in response to sending the transmission: receiving, over the network, product information associated with the cannabis product.

Example 249. A method performed by an electronic device, comprising: implementing a graphical user interface (GUI) on the electronic device that provides an input object that, when selected, activates a camera of the electronic device; acquiring a digital image using the camera, the digital image including a machine-readable code from a cannabis product; sending a transmission over a network that includes the digital image; in response to sending the transmission: receiving over the network, product information associated with the cannabis product.

Example 250. A method performed by an electronic device, comprising: receiving a message over a network from a server, the message requesting permission to activate a camera of the electronic device; activating the camera and acquiring a digital image using the camera, the digital image including a machine-readable code from a cannabis product; transmitting the digital image over the network to the server; in response to the transmitting: receiving at least one message over the network, the at least one message providing information associated with the cannabis product.

### CONCLUSION

Although the foregoing has been described with reference to certain specific embodiments, various modifications thereof will be apparent to those skilled in the art without departing from the scope of the invention as defined by the claims.

As one example, in many embodiments above the lot number is encoded in the machine-readable code. In all such embodiments, a variation is to instead encode the batch number in the machine-readable code. This may save a step of having to map the lot number back to the batch number (i.e. batch ID) of the batch.

As another example, whenever “number” is used herein, it encompasses any arrangement of characters, e.g. it encompasses alphanumeric numbers also.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1-140. (canceled)

141. A method comprising:
receiving, from an electronic device over a network, feedback that was collected by the electronic device in relation to a cannabis product;
storing the feedback in memory in association with information that was obtained from processing a digital image that was captured at the electronic device and that includes a machine-readable code from the cannabis product.

142. The method of claim 141, wherein the machine-readable code uniquely identifies a group of cannabis plants from which cannabis in the cannabis product originates.

143-144. (canceled)

145. The method of claim 141, wherein the machine-readable code is a barcode, and wherein processing the digital image comprises decoding the barcode.

146. (canceled)

147. The method of claim 141, further comprising determining whether the machine-readable code is valid.

148. The method of claim 147, comprising transmitting a message to the electronic device requesting that the feedback be sent from the electronic device in response to determining that the machine-readable code is valid.

149-151. (canceled)

152. The method of claim 141, wherein the information uniquely identifies a cannabis producer and/or cannabis product producer.

153-154. (canceled)

155. The method of claim 141, wherein the feedback comprises one or more of: feedback that is specific to the cannabis product; feedback that is specific to a group of cannabis plants from which cannabis in the cannabis product originates; feedback that is specific to a lot feedback that is electronically linked to a lot number of the lot feedback that is not specific to the cannabis product even though it is collected in relation to the cannabis product feedback that comprises one or more of the following: number of units sold from a lot the cannabis product is associated with; date and/or time of sale of the cannabis product feedback entered by a person associated with the retail store; information obtained from a customer during sale of the cannabis product; identity of a person that sold the cannabis product.

156-163. (canceled)

164. The method of claim 141, further comprising using the information to retrieve information that is specific to the cannabis product, and sending the information that is specific to the cannabis product to the electronic device.

165. (canceled)

166. The method of claim 164, wherein the information that is specific to the cannabis product is retrieved and sent to the electronic device in response to receiving the feedback from the electronic device.

167. The method of claim 164, further comprising receiving the digital image from the electronic device over the network, wherein the digital image acts as a request for the information that is specific to the cannabis product.

168. (canceled)

169. A server comprising:
a network interface;
a memory; and
a processor;
the processor configured to cause the server to:
receive, from an electronic device over a network via the network interface, feedback that was collected by the electronic device in relation to a cannabis product
store the feedback in the memory in association with information that was obtained from processing a digital image that was captured at the electronic device and that includes a machine-readable code from the cannabis product.

170. (canceled)

171. A server comprising a network interface, a memory, and a processor; wherein the processor is configured to execute instructions to cause the server to perform the method of claim 141.

172. A computer program product comprising a computer readable memory storing computer executable instructions thereon that, when executed by a processor, cause a server to perform the method of claim 141.

173-204. (canceled)

205. The method of claim 141, further comprising:
transmitting a message over the network to the electronic device, the message requesting permission to activate a camera of the electronic device;
receiving the digital image over the network from the electronic device, the digital image including the machine-readable code from the cannabis product;
processing the digital image of the machine-readable code to obtain the information.

206-225. (canceled)

226. The method of claim 205, wherein the method is performed by a web application hosted on a server.

227. The method of claim 226, wherein the server communicates with a browser application on the electronic device.

228. The method of claim 227, wherein the message requesting permission to activate the camera is sent to a browser of the electronic device, and the digital image and the feedback are received from the browser of the electronic device.

229-241. (canceled)

242. The method of claim 141, further comprising:
hosting a plurality of webpages on at least one server, each webpage having a uniform resource locator (URL) corresponding to: a respective lot and/or a respective group or batch of cannabis plants;
wherein receiving the feedback comprises receiving the feedback sent to a first URL.

243. (canceled)

244. The method of claim 141, further comprising generating a consumer profile using the feedback.

245. The method of claim 244, wherein the consumer profile includes one or more of: age range; location at which the cannabis product was purchased and/or consumed; feedback from retail stores; sales comparison between different types of the cannabis product.

246-250. (canceled)

251. The method of claim 141, further comprising:
receiving the digital image from the electronic device over the network;
processing the digital image to obtain the information.

252. The method of claim 141, further comprising:
receiving the information from the electronic device over the network, the information having been obtained by the electronic device from processing the digital image.

253. The method of claim 141, further comprising:
receiving, from a second electronic device over the network, second feedback that was collected by the second electronic device in relation to a second cannabis product;
storing the second feedback in memory in association with information that was obtained from processing a digital image that was captured at the second electronic device and that includes a machine-readable code from the second cannabis product.

254. The method of claim 141, further comprising determining whether the information is valid, wherein: in response to determining that the machine-readable code is valid, transmitting a message to the electronic device, the message providing permission for the feedback to be sent by the electronic device.

255. The method of claim 141, wherein a cultivation and/or harvesting and/or processing technique is modified based on the feedback.
